(19) United States
(12) Patent Application Publication
(10) Pub. No.: US 2006/0085370 A1
(43) Pub. Date: Apr. 20, 2006

(54) System for identifying data relationships

(76) Inventors: Robert Groat, Valley Lee, MD (US); Kate Armstrong, Mystic, CT (US)

Correspondence Address: JAGTIANI + GUTTAG, 10363-A DEMOCRACY LANE, FAIRFAX, VA, 22030, US

(21) Appl. No.: 10/476,161

(22) PCT Filed: Dec. 13, 2002
(86) PCT No.: PCT/US02/39853

§ 371 Date: Oct. 27, 2003

Related U.S. Application Data
(60) Provisional application No. 60/339,612, filed on Dec. 14, 2001.

(51) Int. Cl. G06F 17/30

(52) U.S. Cl. 707/1

(57) ABSTRACT

A method for identifying data relationships comprising the steps of providing source data, reducing the data into canonical data, so that the canonical data is capable of being used in an inferential web that shows a user connections between at least two entities. Preferably, the inferential web is displayed to the user and may be stored on data storage medium. The method for identifying data relationship may be implemented by a computer.

### CROSS-REFERENCE TO RELATED APPLICATIONS

This application claims the priority of U.S. Provisional Application No. 60/339,612, entitled “System for Identifying Data Relationships in Financial Transactions,” filed Dec. 14, 2001, the entire disclosure and contents of which is hereby incorporated by reference.

### BACKGROUND OF THE INVENTION

1. Field of the Invention

The present invention relates generally to relationship analysis.

2. Description of the Prior Art

One of the most pressing issues facing our country today is the need to identify and preempt the actions of various terrorists, saboteurs and other criminals. Simultaneously, the financial services sector is currently under the most stringent mandates to comply with the new regulations and therefore has an immediate need to be able to identify and monitor the financing of criminal and terrorist activities across multiple lines of business.

Banks are being forced out of their passive role in the detection of criminal activity into the proactive identification of suspicious activity, leading to a critical need for new technologies. Other financial firms, such as brokerage, insurance, etc., not previously held to reporting and detection requirements, as well as retailers, telecom companies and Internet services providers must also be proactive to identify suspicious activity.

Existing software solutions have been created over the past fifteen years to meet the regulatory requirements for identifying, tracking and reporting on the illegally gotten assets of the criminal as those assets enter the money system. The fraud and anti-money laundering (AML) detection software programs have been developed to meet the reporting requirements of the financial services industry from a regulatory risk management perspective. However, these systems have not been designed for and are incapable of identifying and tracking assets between unknown individuals and unknown relationships.

### SUMMARY OF THE INVENTION

It is therefore an object of the present invention to provide a system for identifying the relationships between entities that is able to identify, analyze and monitor known or suspected entities, their relationships and their undefined, non-obvious associations and activities across multiple organizations and industries.

It is yet another object of the present invention to provide a system for identifying the relationships between entities that allows queries to be made that monitor suspicious individuals and their networks in “real time.”

It is yet another object of the present invention to provide a system for identifying the relationships between entities that allows queries to be made that enable the identification of emerging threats.

It is yet another object of the present invention to provide a system for identifying the relationships between entities that allows queries to be made that extract critical data from seemingly unlikely sources.

It is yet another object of the present invention to provide a system for identifying the relationships between entities that provides an analytical ability to drill down into relationships and activities of both known suspects and their often-unknown associations to proactively identify suspicious behavior.

According to a first broad aspect of the present invention, there is provided a method for identifying data relationships comprising the steps of: providing source data; and reducing the data into canonical data, the canonical data being capable of being used in an inferential web that shows a user connections between at least two entities.

According to a second broad aspect of the invention, there is provided a method for structuring data comprising the steps of: providing a plurality of canonical data; and organizing the canonical data into an inferential web comprising a plurality of nodes and at least one vertex connecting at least two connected nodes of the plurality of nodes, wherein the inferential web shows a user connections between a plurality of entities.

According to a third broad aspect of the invention, there is provided a data structure comprising: canonical data, the canonical data being organized into a plurality of nodes and at least one vertex connecting at least two connected nodes of the plurality of nodes, wherein the data structure comprises an inferential web that shows a user connections between at least two entities.

According to a fourth broad aspect of the invention, there is provided a method of modifying a data structure comprising the steps of: providing an inferential web comprising canonical data, the canonical data being organized into a plurality of nodes and at least one vertex connecting at least two connected nodes of the nodes, wherein the data structure comprises an inferential web that shows a user connections between at least two entities; and modifying the inferential web to form a modified inferential web.

According to a fifth broad aspect of the invention, there is provided a method of alerting a user if a data structure is modified comprising the steps of: providing an inferential web comprising canonical data, the canonical data being organized into a plurality of nodes and at least one vertex connecting at least two connected nodes of the nodes, wherein the data structure comprises an inferential web that shows a user connections between at least two entities; and alerting the user if the inferential web is modified to form a modified inferential web.

According to a sixth broad aspect of the invention, there is provided a computer system implementing a method for identifying data relationships, wherein the method comprises the steps of: providing source data; and reducing the data into canonical data, the canonical data being capable of being used in an inferential web that shows a user connections between at least two entities.

According to a seventh broad aspect of the invention, there is provided a computer system implementing a method for structuring data, wherein the method comprises the steps of: providing a plurality of canonical data; and organizing the canonical data into an inferential web comprising a plurality of nodes and at least one vertex connecting at least two connected nodes of the plurality of nodes, wherein the inferential web shows a user connections between a plurality of entities.

According to an eighth broad aspect of the invention, there is provided a computer system implementing a method of modifying a data structure, wherein the method comprises the steps of: providing an inferential web comprising canonical data, the canonical data being organized into a plurality of nodes and at least one vertex connecting at least two connected nodes of the nodes, wherein the data structure comprises an inferential web that shows a user connections between at least two entities; and modifying the inferential web to form a modified inferential web.

According to a ninth broad aspect of the invention, there is provided a computer system implementing a method of alerting a user if a data structure is modified, wherein the method comprises the steps of: providing an inferential web comprising canonical data, the canonical data being organized into a plurality of nodes and at least one vertex connecting at least two connected nodes of the nodes, wherein the data structure comprises an inferential web that shows a user connections between at least two entities; and alerting the user if the inferential web is modified to form a modified inferential web.

According to a tenth broad aspect of the invention, there is provided a machine-readable medium storing instructions that, if executed by a computer system, causes the computer system to perform method for identifying data relationships comprising the steps of: providing source data; and reducing the data into canonical data, the canonical data being capable of being used in an inferential web that shows a user connections between at least two entities.

According to an eleventh broad aspect of the invention, there is provided a machine-readable medium storing instructions that, if executed by a computer system, causes the computer system to perform a method for structuring data comprising the steps of: providing a plurality of canonical data; and organizing the canonical data into an inferential web comprising a plurality of nodes and at least one vertex connecting at least two connected nodes of the plurality of nodes, wherein the inferential web shows a user connections between a plurality of entities.

According to a twelfth broad aspect of the invention, there is provided a machine-readable medium storing instructions that, if executed by a computer system, causes the computer system to perform method of modifying a data structure comprising the steps of: providing an inferential web comprising canonical data, the canonical data being organized into a plurality of nodes and at least one vertex connecting at least two connected nodes of the nodes, wherein the data structure comprises an inferential web that shows a user connections between at least two entities; and modifying the inferential web to form a modified inferential web.

According to a thirteenth broad aspect of the invention, there is provided a machine-readable medium storing instructions that, if executed by a computer system, causes the computer system to perform a method of alerting a user if a data structure is modified comprising the steps of: providing an inferential web comprising canonical data, the canonical data being organized into a plurality of nodes and at least one vertex connecting at least two connected nodes of the nodes, wherein the data structure comprises an inferential web that shows a user connections between at least two entities; and alerting the user if the inferential web is modified to form a modified inferential web.

Other objects and features of the present invention will be apparent from the following detailed description of the preferred embodiment.

### BRIEF DESCRIPTION OF THE DRAWINGS

The invention will be described in conjunction with the accompanying drawings, in which:

FIG. 1 illustrates the reduction of originating source data into canonical data, according to a preferred embodiment of the present invention for transactional canonical data;

FIG. 2 illustrates how the method of the present invention may be used to connect canonical data nodes with vertices to form transactional webs;

FIG. 3 illustrates how the method of the present invention may be used to connect transactional webs together to form a relational web;

FIG. 4 illustrates an inferential web generated by the method of the present invention;

FIG. 5 illustrates a portion of inferential web that displays three levels of connected vertices from a node of interest;

FIG. 6 illustrates inferential web showing a highlighted path between two nodes of interest;

FIG. 7 illustrates a portion of inferential web showing the path between two nodes of interest;

FIG. 8 illustrates the results of a query performed by an user on an inferential web, according to a preferred embodiment of the present invention;

FIG. 9 illustrates a monitoring query performed on an inferential web 900, according to a preferred embodiment of the present invention;

FIG. 10 is a flowchart illustrating how the method of the present invention may be used to generate an inferential web;

FIG. 11 is a flowchart that generates the path between two nodes of interest in inferential web as shown in FIG. 6;

FIG. 12 is a flowchart of the investigation of links in the path between two nodes of interest in inferential web, as shown in FIG. 8;

FIG. 13 is a flowchart of a query in inferential web such as shown in FIG. 9;

FIG. 14 is a flowchart illustrating the generation of connected vertices between nodes from different domains;

FIG. 15 is a flowchart of illustrating the generation of an inferential web having nodes and connected vertices from canonical data;

FIG. 16 illustrates a weighed vertex connecting two nodes in an inferential web;

FIG. 17 is a flowchart illustrating a process of the present invention for creating weighed vertices between nodes in an inferential web;

FIG. 18 illustrates an inferential web having an encryption protection that limits a user from viewing the underlying data;

FIG. 19 is a flowchart of an encryption process;

FIG. 20 illustrates a process for collapsing two nodes into a single node;

FIG. 21 illustrates a process for expanding a node into two nodes;

FIG. 22 is a flowchart of a collapsing process;

FIG. 23 is a flowchart of an expanding process;

FIG. 24 illustrates the combination of two inferential webs that have a common node to form a single inferential web;

FIG. 25 is a flowchart of an inferential web combination process according to a preferred embodiment of the present invention;

FIG. 26 is a flowchart of an extraction operation according to a preferred embodiment of the present invention;

FIG. 27 illustrates the operation of a query that causes a portion of an inferential web of the present invention to be modified to form a modified inferential web;

FIG. 28 is a flowchart of a query performed on an inferential web according to a preferred embodiment of the present invention; and

FIG. 29 is a flowchart illustrating a process of identifying data relationship according to a preferred embodiment of the present.

### DETAILED DESCRIPTION OF THE PREFERRED EMBODIMENT

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “user” refers to any individual, organization, computer system, software, etc. that uses, views, investigates, analyzes, etc. the data and/or inferential web of the present invention.

For the purposes of the present invention, the term “entity” refers to any person, place or thing that are capable of being connected by relationships or transactions to another person, place or thing. An entity may be an individual person, a group of people, data, an event, a date, a time, a location, etc. Entities may be groups of people such as voluntary organizations, corporations, partnerships, agencies, etc. that are capable of being connected by relationships or transactions. Entities may include physical things, such as data. Entities that are events may include things such as actions including the transmission of an object or data, the transaction of monies, a communications between individuals, etc. Entities may be places such as any type of geographical location, such as a city, a country, a street address, etc. In an inferential web, a node may represent an entity or a web of entities and possibly connecting vertices that have been collapsed into a single node.

For the purposes of the present invention, the term “entity sets” refers to a collection of entities sharing a common characteristic. For example, an entity set may consist of all the people belonging to the same corporation or family. An entity set may include the events, such as financial transactions, between the people belonging to a particular corporation.

For the purposes of the present invention, the term “connection” refers to any relationship or transactional connection or link between at least two entities. A connection may or may not be associated or represented by vertex between the connected entities. For example, two nodes may be connected by being associated with aliases for the same individual and there may be no vertex connecting the nodes. Connections may be direct (referential), indirect (inferential), implied (e.g. inductive or deductive association).

For the purposes of the present invention, the term “relationship” refers to any type of is-a relationship or, has-a relationship, as those terms are commonly used in the art of relationship analysis and object-oriented programming and as further defined below. Examples of is-a and has-a relationships are described in U.S. Pat. No. 6,480,856 to McDonald et al. Relationships may be natural, derived or causal relationships that are used to define an entity set.

For the purposes of the present invention, the term “is-a relationship” refers to conventional is-a relationships as well as entities that are related to each other due to sharing a common characteristic. Examples of is-a relationship include: individuals being members of the same organization, individuals being from the same country of origin, individuals living in the same city at the same time, an organization being part of a larger organization, etc.

For the purposes of the present invention, the term “has-a relationship” refers to conventional has-a relationships as well as entities that are related to each other through possessing or being connected to another entity. Examples of has-a relationships are individuals having the same mailing address, individuals having the same IP address, individuals having the same telephone number, individuals attending the same flight school at around the same time, a bank account used by the same individuals, two or more names or aliases associated with the same individual, etc

For the purposes of the present invention, “natural relationships” refers to relationships based on inherent characteristics or traits. For example, a entity set may be made of all monetary transactions over a defined amount, all phone calls made from the same phone number, all phone calls made to the same phone number, all medicines including at least one of the same ingredients, etc.

For the purposes of the present invention, the term “derived relationship” refers to relationships as those stemming from a connection among or across entities or entity sets. Derived relationships, then, can be either within an entity set (e.g. people) or across entity sets (e.g. objects in a particular place, or events at a particular time). Examples of derived relationships include: all individuals traveling to a particular place on a particular date; the relationship between salt and saltwater; the relationship between precursor chemicals and chemical reagents; etc. Derived relationships may have a source(s) and destination(s) entity(ies), that may be natural, assigned, or derived.

For the purposes of the present invention the term “causal relationship” refers to causal relationships such as those in which one entity set acts upon (impacts) another. For example, people impacting events, objects impacting other objects, etc. (e.g., criminals funding illegal activities, the action or interaction of medicine on infectious devices, the impact of infectious devices on people, etc.) are examples of causal relationships. Causal relationships will tend to have a source and destination entity, which may be natural, assigned, or derived.

For the purposes of the present invention, the term “source” refers to an originating transactional entity. For example if a first individual transfers money to a second individual, the first individual is the source.

For the purposes of the present invention, the term “transaction” refers broadly to any point to point connection from a source to a destination. The method of the present invention uses a broad definition of a transaction as any point-to-point connection of data, for example an e-mail, a transport log, a financial dealing, a telephone call, etc. Each transaction shares common data elements with other point-to-point domains. Additional transaction may include a financial transaction that involves an owner, a timestamp, a source, a destination, and content. This same framework applies to all point-to-point domains, e.g. e-mails, phone calls, airline travel, shipped packages, etc.

For the purposes of the present invention, the term “data” refers to information relating to a connection. Data may include transaction source, destination, content, timestamp, type, transaction entity demographics (name, SS ID, address etc.), location, etc.

For the purposes of the present invention, the term “canonical data” refers to either relationship canonical data or transactional canonical data or the combination of canonical data and transactional data.

For the purposes of the present invention, the term “relationship canonical data” refers to data that includes no more than the following three data elements: two or more entities and one or more connections between them

For the purposes of the present invention, the term “transactional canonical data” refers canonical data containing one or more of the following five data elements: source, destination, type, timestamp, and direction.

For the purposes of the present invention, the term “source” refers to an originating transactional entity. For example if a first individual transfers money to a second individual, the first individual is the source.

For the purposes of the present invention, the term “destination” refers to a transactional entity receiving a transaction. For example if a first individual transfers money to a second individual, the second individual is the destination.

For the purposes of the present invention, the term “type” refers to a way of describing a particular connection. For example, the following are types of connections: monetary transfers, cell phone calls, e-mails, group affiliations, etc.

For the purposes of the present invention, the term “timestamp” refers to the point in time or period assigned to a particular connection or particular connections. For example, the timestamp may be a date that money transfer occurred, a period of days, months or years two individuals lived in the same city or home, the time a call was made, the date and time an air flight was taken, the time and date a package was shipped and/or received, etc.

For the purposes of the present invention, the term “direction” indicates the source and destination of a transaction. From source to destination is a single directional transaction. Some transactions are bi-directional such as face-to-face meetings.

For the purposes of the present invention, the term “optional data” refers to data that is not canonical data.

For the purpose of the present invention, the term “optional data element” refers to data elements that are not canonical data elements. Examples of optional data elements include: groups to which an individual belongs, groups to which an individual belongs, amount of money transferred, geographic location of an individual or transaction, text content within an e-mail, content of a recorded conversation, photographs, images, file format of transaction, religious affiliation, etc.

For the purposes of the present invention, the term “source data” refers to a combination of canonical data and optional data. In addition to canonical data, source data may include optional data relating to a connection, such as, the contents of: emails, telephone calls, transport logs, newspaper articles, internal or external documents, radio and television broadcasts, etc.

For the purposes of the present invention, the term “node” refers to a location in a web including at least one canonical data. A node may contain more than one canonical data and may also contain optional data elements. A node may correspond to a single entity or may correspond to a section of a web of nodes and connecting vertices or a number of unconnected nodes that have been collapsed into a single node.

For the purposes of the present invention, the term “vertex” refers to a connection between two nodes that is capable of being made visible to a user as a connection between two node. The value of the connection may be determined by a scalar, or multivariate function. The value of the connection assigns a weight to the vertex. A vertex may be bi-directional and may have different a different weight in each direction. A vertex may be displayed to a user or may be merely kept track of in software.

For the purposes of the present invention, the term “secure node” refers to any node containing information that requires authorization before the information may be used. For example, before viewing the information in a secure node, a user may be requested to enter a password, submit to a biometric scan, or submit to another type of authentication procedure.

For the purposes of the present invention, the term “digraph” refers to the conventional meaning of a digraph, i.e. a directed graph.

For the purposes of the present invention, the term “inferential web” refers to a digraph containing nodes and vertices. For the purposes of the present invention the term “inferential web” refers to data structured into nodes and vertices that may be displayed or used by a user to determine connections between individuals.

For the purposes of the present invention, the term “combinable” refers to the ability of two or more webs to be linked at one or more nodes.

For the purposes of the present invention, the term “extractible” refers to the ability to separate a section of an inferential web by cutting links between one or more nodes.

For the purposes of the present invention, the term “collapsible” refers to the ability of an inferential web of the present invention to be reduced to a simpler web, i.e. a web having fewer nodes and/or vertices.

For the purposes of the present invention, the term “expandabile” refers to the ability of an inferential web of the present invention to be made more complicated i.e. a web having more nodes and/or vertices.

For the purposes of the present invention, the term “computer system” refers to any type of computer system that implements software including an individual computer such as a personal computer, mainframe computer, mini-computer, etc. In addition computer system refers to any type of network of computers, such as a network of computers in a business, the Internet, personal data assistant, cell phone, etc.

For the purposes of the present invention, the term “visual display device” includes any type of visual display device such as a CRT monitor, LCD screen, etc.

For the purposes of the present invention, the term “data storage medium” refers to any media on which data may be stored. Examples of data storage media include such as floppy disks, Zip® disks, CD-ROM, CD-R, CD-RW, DVD, flash memory, hard disks, optical disks, tape drives, etc.

### DESCRIPTION

Using existing technology, such as data mining software, a user must know what to look for to track assets. The user cannot use existing software to ask questions, such as identify from where is the money coming, to whom is it going, and for what is it targeted? No amount of reporting, no reduction in transaction limits required to be monitored, no broadening of the regulations to other industries will, in and of themselves, provide an adequate solution that uses the existing software. In fact, instituting any of these measures, without a fundamentally different technology solution, will only serve to exacerbate existing problems of not identifying the relationships between entities involved in fraudulent or terrorist activities.

Existing software has been developed to only report transactional analysis within a given domain. For instance, most fraud and AML solutions generate compliance reports of funds transfers that reach certain thresholds. In a typical data schema the data records are stored in a hierarchical layout containing accounts followed by a transaction domain log. Traditional data mining software can slice this transaction domain log and uncover potentially fraudulent transfers by examining scalar transfer amounts based on a predetermined set of rules. Although this meets most of the regulation compliances, it can be easily thwarted by anyone who knows these preset rules, and is insufficient to answer the questions necessary to proactively identify criminal activity.

For a user to successfully identify, track, and curtail activities, requires that a user be able to uncover and analyze previously unknown, and often undefined, relationships between individuals and across institutions. These previously unknown relationships are not identifiable by existing data mining software. Simultaneously, while uncovering and analyzing these previously unknown relationships, the user must utilize data obtained from a legal source. Therefore, a solution that can address all of these questions may allow a user to identify, prevent and/or deter terrorism and other criminal activities.

The method of the present invention has significant advantages over existing relationship analysis methods that only attempt to either identify entity element relationships within a defined entity set, e.g. data mining to identify natural relationships, or to identify connections within a given entity set, e.g. link structure, as described in U.S. Pat. No. 6,182,091 to Pitkow, et al., the entire contents and disclosure of which is hereby incorporated by reference.

The present invention overcomes the shortcomings of existing software and is able to answer these questions. In addition, the present invention may allow an user to proactively identify and monitor not only known suspects but also their non-obvious associations and activities across multiple organizations and domains, e.g. email, telephone calls, transport domain logs, financial data, etc. The present invention is an improvement over previous resource intensive forensic accounting methodologies currently employed to investigate relationships between entities. The present invention has a number of applications for any industry or institution that requires identification and analysis of relationships across multiple databases and domains. A preferred software product for carrying out the method of the present invention is Primitas™ available from the Primiter Group.

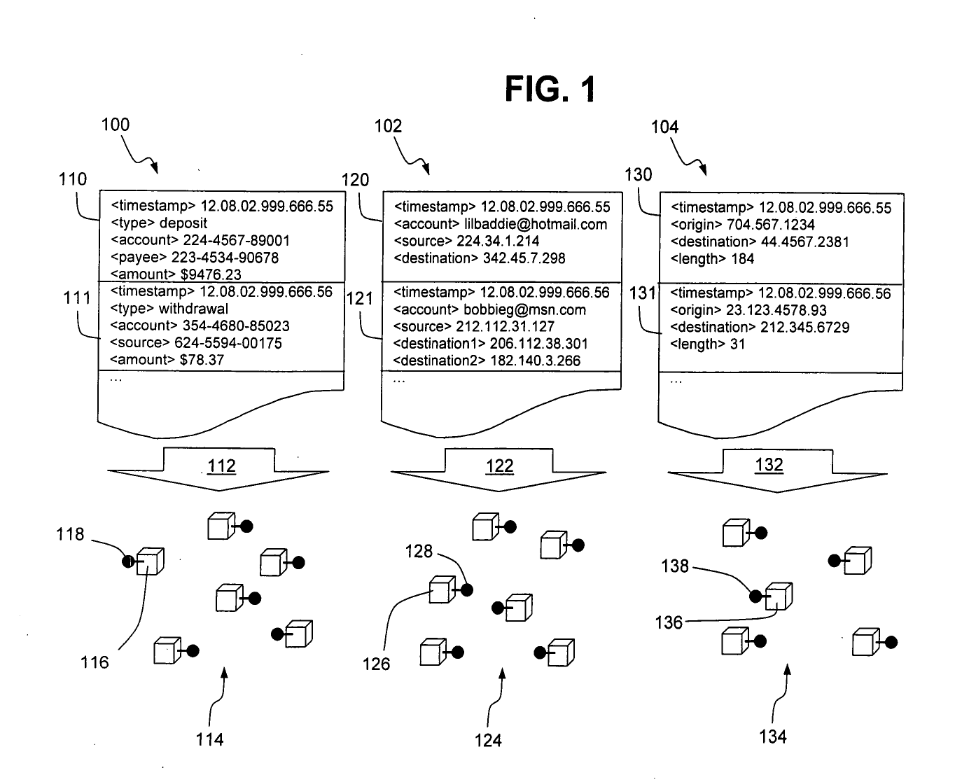

FIG. 1 illustrates the reduction of originating source data into canonical data, according to a preferred embodiment of the present invention for transactional canonical data. Originating source data comes from a financial transaction domain log 100, a ISP e-mail domain log 102, and a telephone call domain log 104. Financial transaction domain log 100 contains a deposit transaction 110 and withdrawal transaction 111. Deposit transaction 110 has data elements that include a timestamp, transaction type, account number, payee's name, and amount. Withdrawal transaction 111 has data elements that include a timestamp, transaction type, account number, source of withdrawal, and amount. As shown by arrow 112, the method of present invention uses transaction domain log 100 to generate a set of canonical data 114 comprising nodes 116 and unconnected vertices 118.

Although the financial transaction domain log shown in FIG. 1 includes only two transactions, a transaction domain log of the present invention may contain any number of transactions, including one transaction, within the transaction domain log. Preferably, each transaction within a transaction domain log includes common elements. For convenience, only the canonical data in each log is shown. Optional data such how much money was transferred in a payment, what was said in a phone call, whether an e-mail is formatted in text or html, etc. may be present in the logs as well as the canonical data.

E-mail domain log 102 contains e-mail message 120 and e-mail message 121. E-mail message 120 has elements that include a timestamp, sender's account, sender's IP address, and recipient's IP address. E-mail message 121 has elements that include a timestamp, sender's account, sender's IP address, and two recipients' IP address. As shown by arrow 122, the method of present invention uses e-mail domain log 102 to generate a set of canonical data 124 comprising nodes 126 and unconnected vertices 128.

Although the e-mail domain log shown in FIG. 1 includes only two e-mails, an e-mail domain log of the present invention may contain any number of e-mails, including one e-mail, within the e-mail domain log. Preferably, each e-mail within an e-mail domain log includes common elements.

Telephone call domain log 104 contains telephone call 130 and telephone call 131. Telephone call 130 has elements that include a timestamp, originating phone number, destination phone number, and length of time of call. Telephone call 131 has elements that include a timestamp, originating phone number, destination phone number, and length of time of call. As shown by arrow 132, the method of present invention uses telephone call domain log 104 to generate a set of canonical data 134 comprising nodes 136 and unconnected vertices 138.

Although the telephone call domain log shown in FIG. 1 includes only two telephone calls, a telephone call domain log of the present invention may contain any number of telephone calls, including one telephone call, within the telephone call domain log. Preferably, each transaction within a telephone call domain log includes common elements.

Although the canonical data nodes are shown in FIG. 1 as being generated in three separate steps, the canonical data nodes for the transaction domain log, e-mail domain log, and telephone domain log may be derived simultaneously.

Other domains, such as package shipping, retail, etc. may have corresponding domain logs that may be reduced to canonical data. These domain logs may also contain originating source data from at least one event, such as a transaction or message. It should be appreciated that the common elements may vary slightly between domain logs, but the common elements within each domain log remain the same.

Because the originating source data often exists in a hierarchical form, each unique to domain and/or domain log, it cannot be analyzed outside of its existing structure using existing solutions. The method of the present invention is able to use the existing data structure of the originating source data, and reduces the data to set of least common denominators, or the canonical data.

Preferably, the method of the present invention generates the canonical data by processing the originating data source using conventional normalization operations.

Preferably, when generating the canonical data, the method of the present invention will also place an identifier that associates the canonical data to its originating source so that the original data can be viewed, when needed. The method of the present invention does not modify or delete the originating source data in generating the canonical data.

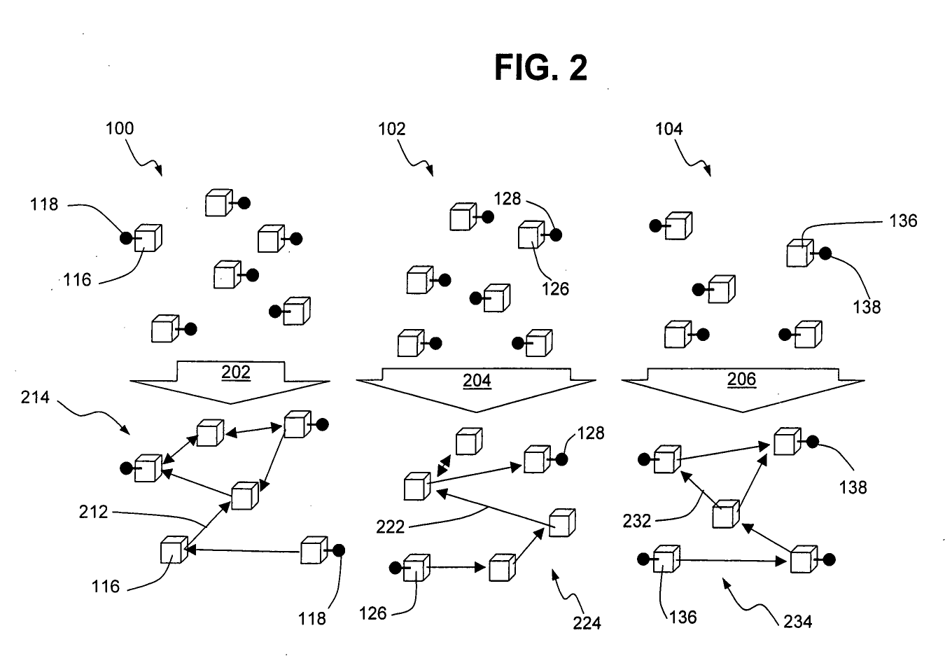

FIG. 2 illustrates how the method of the present invention may be used to connect canonical data nodes with vertices to form transactional webs. At steps 202, 204 and 206, canonical data nodes 116 are connected to each other by transactional vertices 212 to form a transactional web 214, canonical data nodes 126 are connected to each other by transactional vertices 222 to form a transactional web 224, canonical data nodes 136 are connected to each other by transactional vertices 232 to form a transactional web 234, respectively.

Although the canonical data nodes are shown in FIG. 2 as being connected in three separate steps to form transactional webs, the canonical data nodes for the transaction domain log, e-mail domain log, and telephone domain log may be processed simultaneously to form the transactional webs.

According to the method of the present invention, once the data has been reduced to canonical form, algorithms may be applied to identify, analyze and monitor relationships and connections among, across and between the entities' information captured in the canonical data to connect the vertices of the nodes.

Preferably, the web may be generated using transactional connections between the nodes. A connection may consist of at least two linked vertices from two nodes. It should be appreciated the method of the present invention may create transactional connections between any types of nodes that are generated from any domain log, such as financial, e-mail, telephone, retail, shipping, etc. In addition, transactional connections may be created between two or more domain logs in generating the transactional web.

Preferably, a referential or direct connection is between two entities that have a direct connection in the domain log. The direct connection requires the two entities to have one degree of separation in a transaction. For example, in a financial transactional domain person A sends person B money. This would create a one-way direct connection between the source, person A, and the destination, person B. The method of the present invention may display the connection of vertices using an arrow pointing from the source to the destination. In addition, the method of the present invention may store the referential webs on data storage medium such as a hard drive, optical storage disk, etc Alternatively, in an ISP e-mail domain person A may send person B an e-mail and person B replies. This would create a multi-directional connection between the originating source, person A, and the original destination, person B.

The generation of referential or direct connections of vertices may be commutative, transitive or associative.

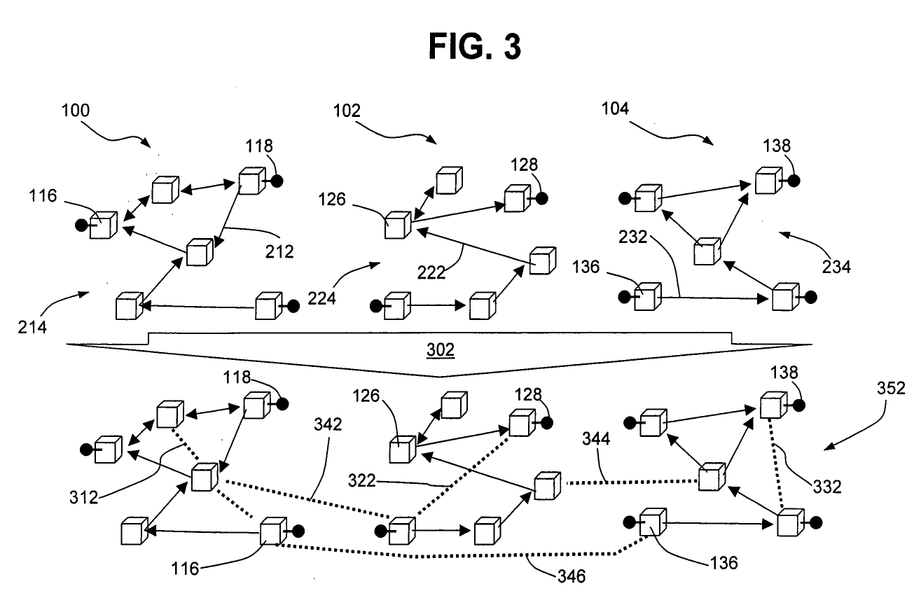

FIG. 3 illustrates how the method of the present invention may be used to connect transactional webs together to form a relational web. At step 302 relationship vertices 312 are formed between some of nodes 116, relationship vertices 322 are formed between some nodes 126, relationship vertices 332 are formed between some nodes 136, relationship vertices 342 are formed between some nodes 116 and nodes 126, relationship vertices 344 are formed between some nodes 116 and nodes 136, and relationship vertices 346 are formed between some nodes 126 and nodes 136 to form an inferential web 352.

In a preferred embodiment, the method of the present invention may generate the relationship vertices based on two or more entities being located in a particular area, known alias of entities, known relationships, etc. In addition, the relationship connections may be “is-a” or “has-as” links.

It should be appreciated the method of the present invention may be used to form relationship connections between any type canonical data nodes that are generated from any domain log, such as financial domain logs, e-mail domain logs, telephone domain logs, retail domain logs, shipping domain logs, etc. In addition, relationship connections may be created between two or more domain logs in generating the inferential web.

The relationship vertices may represent inferential or indirect connections. A relationship connection may consist of at least two linked vertices from at least two nodes. The indirect connection requires the two entities to have at least more than one degree of separation. The separation may exist outside the same transaction. The inferential connection may be generated when person A sends money to person B, who calls person C. The method of the present invention would generate an inferential connection between person A and person C. Alternatively, a relationship connection may be a new connection formed between nodes without linking vertices. For example, if person A sends an e-mail to person B, and person B and person C are members of organization D, then person A and person C are connected by a relationship connection. The connection may be one direction or multi-directional.

The inferential web may have at least one transactional connection and at least one non-transactional connection or relationship connection.

The generation of relationship connections may be commutative, transitive or associative.

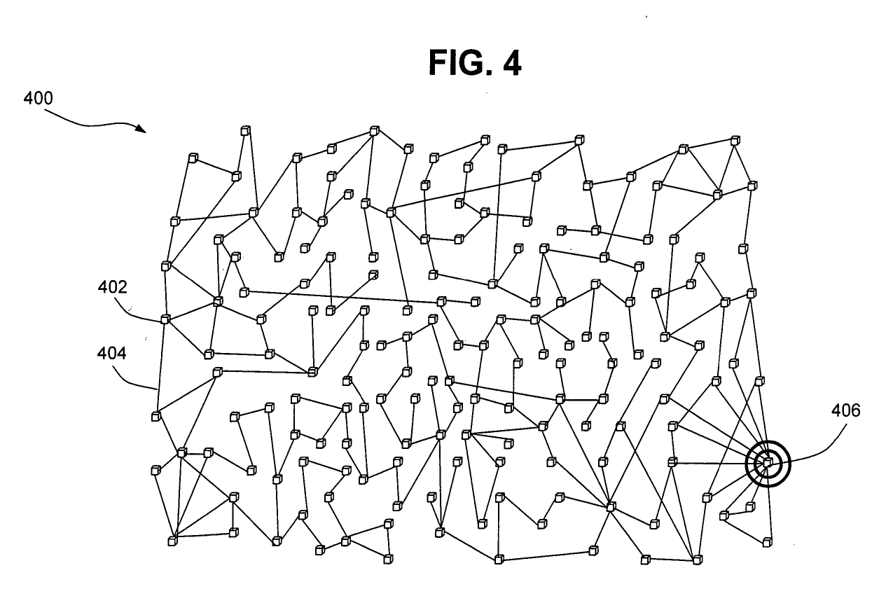

FIG. 4 illustrates an inferential web 400 generated by the method of the present invention. Inferential web 400 has nodes 402 connected by vertices 404 and includes a node of interest 406 that a user wishes to investigate.

An inferential web may be generated by using multiple domain logs, reducing the information to canonical form, then linking the nodes by their vertices using direct connections and relationship connections. The connections between the nodes in the web may have different properties, for example, weighting, i.e. strength of the connection or direction. The connected vertices of inferential web may be direct or relationship connections.

Preferably, an inferential web may be a normalized inferential web, having equal weighting and may be bi-directional. Algorithms and business logic may be applied to this inferential web and parameters may be applied dynamically. For instance the weighting may be different depending on the search a user may initiate. A query may request stronger weighting, for example, based on larger volumes of money flow, or frequency of telephone contact.

Once the inferential web is generated, a user may analyze the connected vertices between the nodes. For example, a node of interest may appear highlighted or may be selectable by a user. When investigating the node it may appear to be a central point of activity to many other nodes having many connected vertices to other nodes. The node of interest in FIG. 4 is an example of a node being the central point of activity. Due to the non-hierarchical structure between the nodes the user does not have to know any details about any of the entity information contain in the canonical data of the node in the inferential web to observe a relationship between nodes. Preferably, the user does not even have to know anything about the node of interest or highlighted node, other than that there is activity that the user wants to investigate.

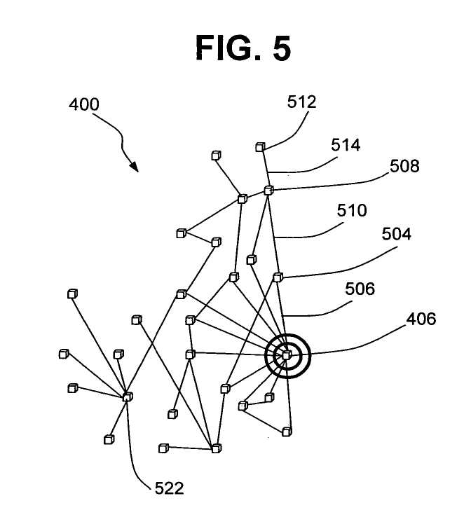

FIG. 5 illustrates a portion of inferential web 400 displaying three levels of connected vertices from node of interest 406, according to a preferred embodiment of the present invention. Node of interest 406 is connected to first level nodes 504 by first level vertices 506. Node of interest 406 is connected to second level nodes 508 by first level vertices 504 and second level vertices 510. Node of interest 406 is connected to third level nodes 512 by first level vertices 506, second level vertices 510 and third level vertices 514. As illustrated in FIG. 5, a keystone node 522 of second level nodes 508 appears to be particularly important in connecting node of interest 406 to the rest of inferential web 400.

Preferably the connected vertices may have direct connections or relationship connections. The method of the present invention may also display the three levels of connected vertices from a suspect node within the entire inferential web. Additional levels of connected vertices may be shown as desired by the user. Depending on the nodes in an inferential web, there may be several levels of connected vertices. The path between of any two nodes within the inferential web may determine which level one node is from another. For example, node A may have first level vertices with node B. Node A may have a second level vertices and first level vertices with node C. Node A may also have first level vertices with node C. In this example, node A and C may have first level node path or a second level node path depending on the path a user chooses.

Using the method of the present invention, a user may run a variety of queries on the inferential web to investigate vertices between nodes. One query the inferential web may involve extracting all vertices between the node of interest and all three level nodes from the node of interest. The query may show that there is a node in the second level that may be a pivotal point in the inferential web. So, while the node of interest may be sending and receiving lots of e-mails or money, it is this pivotal node that actually appears to be the keystone for distribution to the rest of the inferential web. The user may run further queries on this pivotal node to determine further relationships to the node of interest.

Alternatively, a user may run a query that simulates the affect on the connected vertices within an inferential web when one node is removed, inserted, or altered. A similar query may that simulate the affect on the connected vertices within an inferential web when more than one node is removed, inserted, or altered.

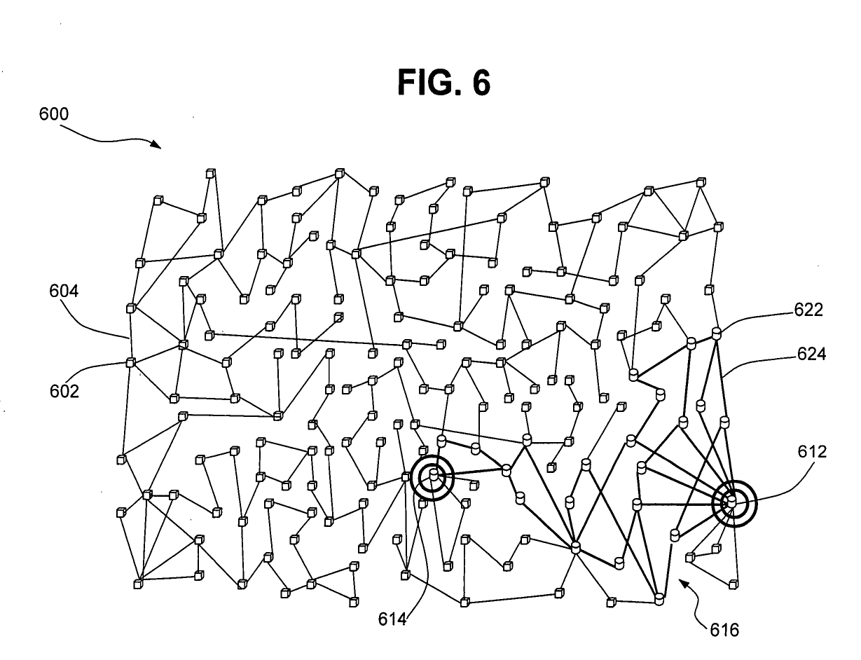

FIG. 6 illustrates an inferential web of the present invention that may be used to find the connections between two nodes of interest. Inferential web 600 includes nodes 602 connected by vertices 604. Two nodes of interest are identified at node of interest 612 and node of interest 614. A user (not shown) performs a query to determine the most direct paths shown generally by arrow 616 between node of interest 612 and node of interest 614 shown by highlighted nodes 622 and connecting highlighted vertices 624.

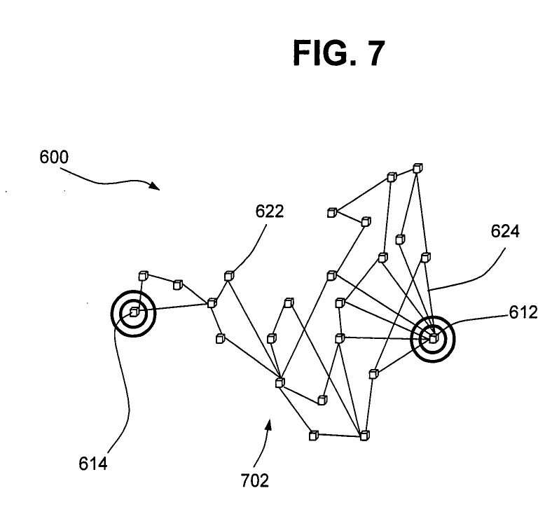

FIG. 7 illustrates a portion 702 of inferential web 600 including only node of interest 612, node of interest 614, highlighted nodes 622, and connecting highlighted vertices 624 so that the paths between node of interest 612 and node of interest 614 may be more easily seen.

Preferably, the query to identify all the possible paths between two nodes of interest may be accomplished in real time. The query may be performed on a portion of an inferential web of the entire web as desired by the user.

In running a query to establish possible paths, the user does not have to know what kind of relationship any of these nodes have with each other before running the query. The user does not have to know any specific information about these nodes to analyze or monitor the connections between the two nodes of interest. By viewing all the possible paths, the user may be able to determine a pivotal point in the path of connected vertices to investigate further. It should be appreciated that any number of queries in any order may be performed on the inferential web.

Additionally nodes of interest may be added to the query as required by the user's investigation.

Preferably, the method of the present invention may allow a user to set up a monitoring query that identifies the path between two nodes of interest to immediately alert the user to any changes in the nodes or connected vertices in the path. The changes may include the addition or deletion of nodes, change in direction or amount of flow, etc. The alert may be a visually alert on the display, message, sound alarm, creating an audit log, light indicator, etc. The user may investigate each node in the path and the canonical data contained within the node.

A preferred query might identify a suspicious node in the path using modern graph theory. According to modern graph theory, algorithms may determine which node, when removed from the inferential web or a portion thereof, causes the maximum impact of reduced connectivity between the remaining nodes. A user may examine the node with the maximum impact. This examination may involve selecting on the node and expanding the inferential web or viewing the canonical data contained within the node. When the canonical data is protected by agreement or law, the user may then seek to obtain a subpoena to obtain the canonical data.

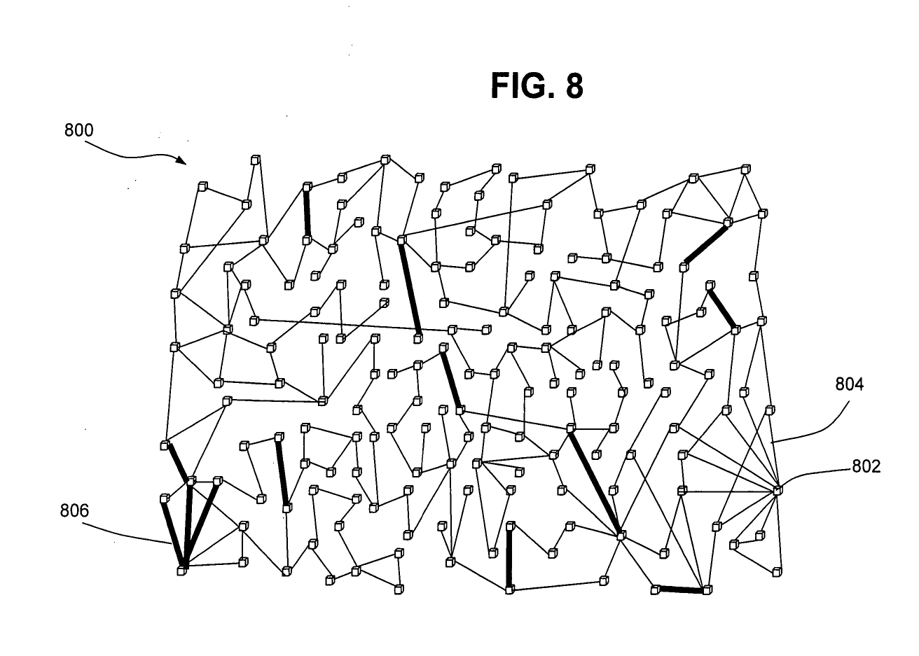

FIG. 8 illustrates a query performed on an inferential web 800, according to a preferred embodiment of the present invention. Inferential web 800 has nodes 802 and connected vertices 804. After query is performed, vertices 806 that satisfy the query of inferential web 800 are highlighted on a visual display apparatus so that the user is able to see which the results of the user's query.

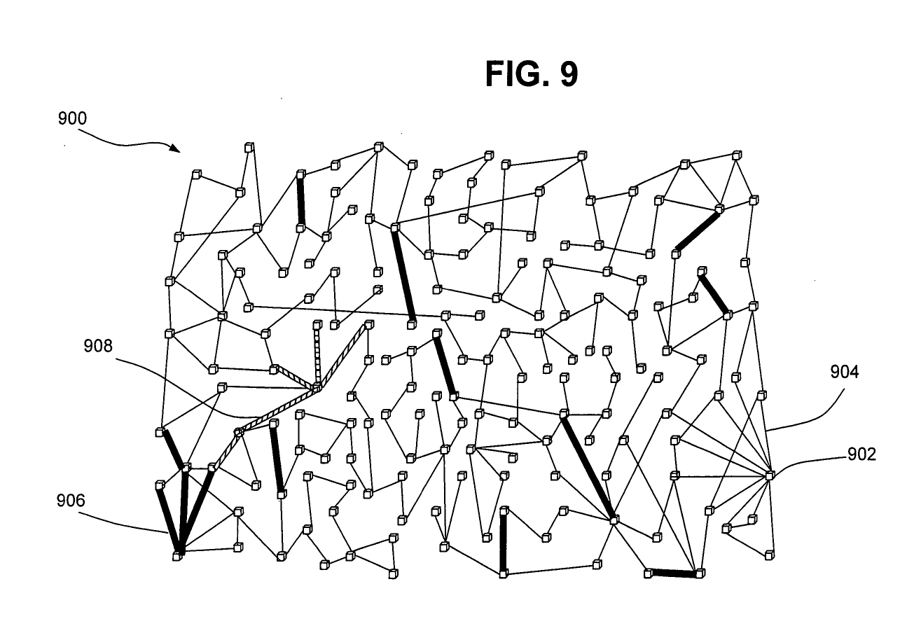

FIG. 9 illustrates a monitoring query performed on an inferential web 900, according to a preferred embodiment of the present invention. Inferential web 900 has nodes 902 and connected vertices 904. The results of the query are shown on the inferential web 900 by highlighted connected vertices 906. The monitoring query will continue to perform the query on changes in the inferential web and display any change with identified connected vertices 908 between nodes 902.

Preferably, the method of the present invention has inherent monitoring capabilities to allow a user to be immediately notified of any changes to the inferential web or connections within the inferential web. For example, the additional identified connected vertices in FIG. 9, may represent the transfer of an object, such as money. Person A may transfer $30,000 to person B, who transfers $30,000 to person C, who in turns transfers $10,000 each to person D, person E and person F. Alternatively, additional connected vertices may be a new e-mail that is sent by one person and forward to three other people. The monitoring feature allows a user to trace the movement of an object through the inferential web by identifying the changes to the inferential web.

For convenience, in the embodiments of the present invention shown in FIGS. 1-9, each node corresponds to a single entity. However, the present invention also encompasses embodiments in which one or more nodes comprise a web of nodes connected by vertices that have been collapsed into a single node. For example, a single node may represent an individual or a family or business comprising several connected individuals. Similarly, a single node may represent a single phone number or a collection of phone numbers associated with a given individual or family or business.

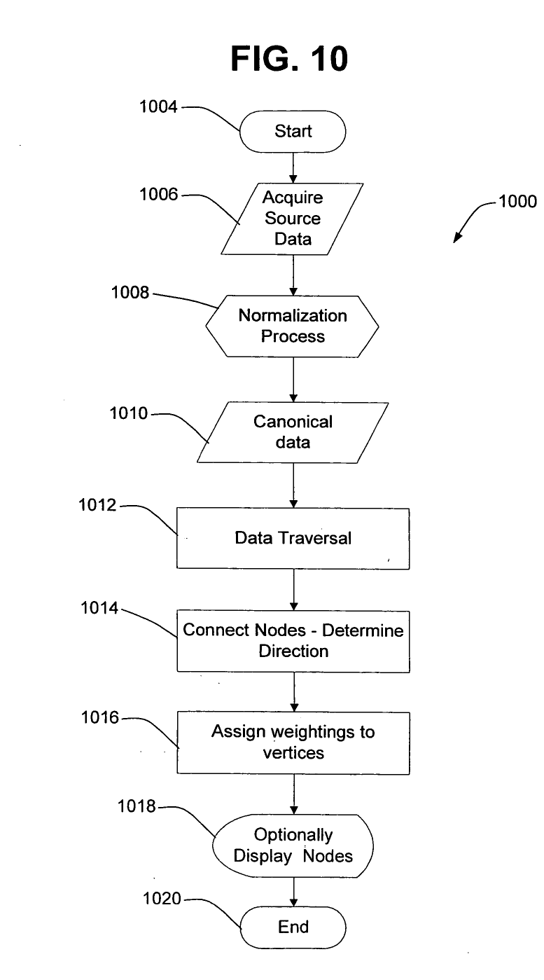

FIG. 10 is a flowchart illustrating how the method of the present invention may be used to generate a preferred inferential web, such as the inferential web illustrated in FIG. 4, using a process 1000. In step 1004 the process begins by acquiring the originating source data 1006 contained within a domain log. In step 1008 the originating source data is normalized into canonical data 1010. In step 1010 the canonical data is traversed at the source of each vertex. In step 1012 direct and indirect connections are generated using the vertices of nodes. In step 1014 the individual vertices that form the connections are assigned a weighed value by the user or a pre-determined process. The user may select to display certain connections when generating an inferential web in step 1016. The inferential web may be displayed in step 1018 for the user to investigate connections between nodes. In step 1020, the process ends and may be repeated to include additional originating source data or additional domains.

Preferably, the process illustrated in FIG. 10 uses modern graph theory combined with standard tree navigation to generate the inferential web. A preferred modern graph theory of the present invention is a conventional modern graph theory as described in Béla Bollobás, Modern Graph Theory, Graduate Texts in Mathematics, vol. 184, (1998) and Reinhard Diestal, Graph Theory, Graduate Texts in Mathematics, vol. 173, (1997), the entire contents of which are hereby incorporated by reference.

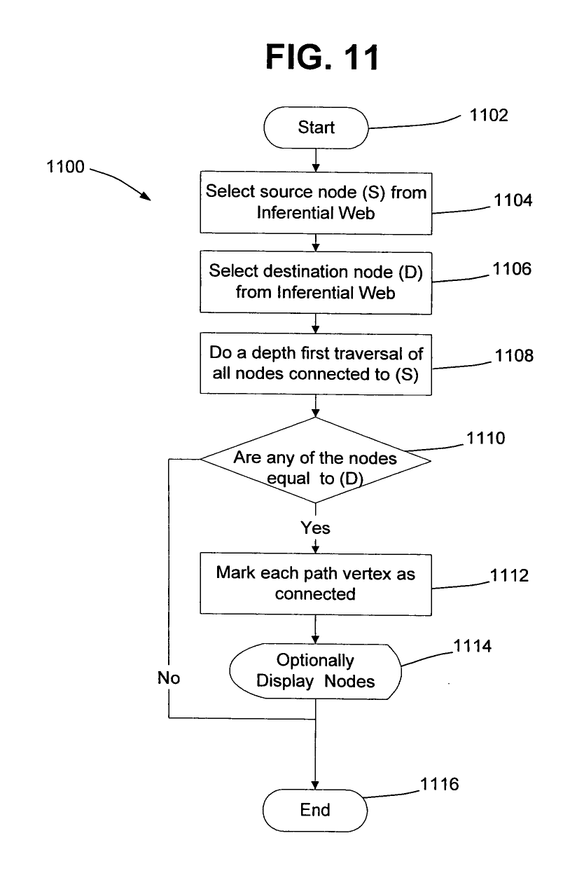

FIG. 11 is a flowchart that generates the path between nodes of interest in an inferential web as shown in FIG. 7, according to a preferred embodiment of the method of the present invention. In process 1100 at step 1102, process 1102 begins when an inferential web (not shown) is generated. The user selects a source node to investigate in step 1104. In step 1106, the user selects a destination node to investigate. In step 1108, the method of the present invention traverses all vertices connected to the source node to generate first level, second level, n+1 level, etc., nodes and connected vertices. In step 11110, the method of the present invention determines whether any of the connected vertices generated in step 1108 are linked to the destination node. If the method of the present invention does establish a link between the source node and destination, all the paths are displayed by connecting the vertices of each node in the path in step 1112. The inferential web may be display in step 1114 for the user to investigate. Once the display is complete, the process in step 1116 ends and the user may repeat the steps for the remaining nodes by repeating the steps at step 1104. If the method of the present invention does not establish a connection between the source node and destination, no inferential web will be displayed and the process ends in step 1116.

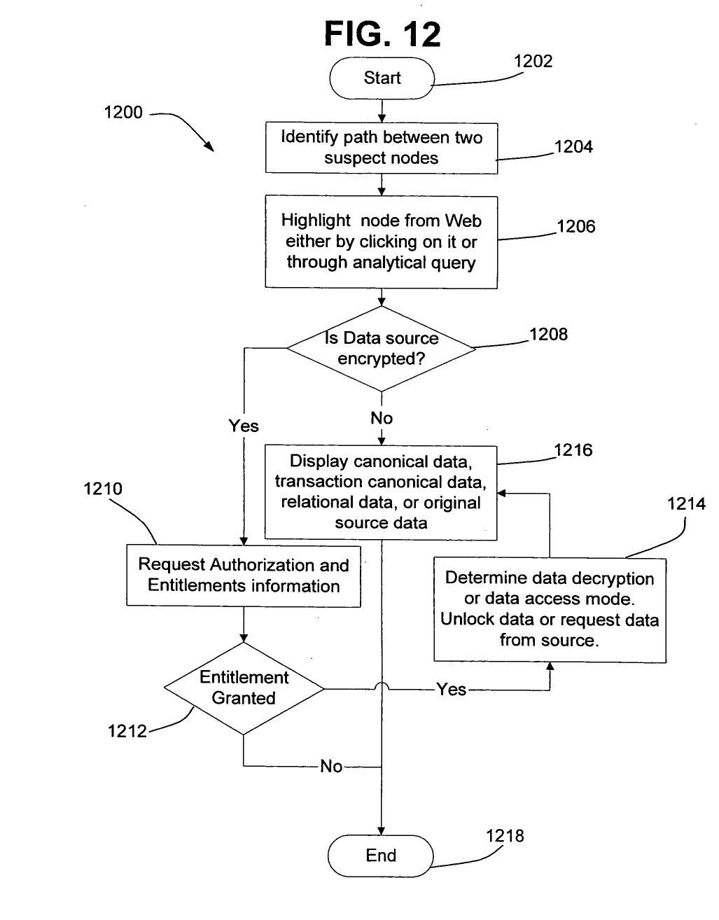

FIG. 12 is a flowchart of the investigation of links in the path between nodes of interest in inferential web as shown in FIG. 8, according to a preferred embodiment of the method of the present invention. In process 1200 at step 1202, process 1200 is initiated by generating an inferential web. In step 1204, the method of the present invention identifies the links between two nodes of interest and displays a portion of the inferential web. In step 1206, the user may select any node in the path to investigate a linking account or node. The user may click or highlight the desired node for investigation. In step 1208, the method of the present invention checks to determine if the node's canonical data is encrypted. If the canonical data is encrypted, in step 1210 a request for authorization is sent by the method of the present invention to the source of the encrypted canonical data. In step 1212, the source of the canonical data determines whether authorization should be granted. If yes, in step 1214 the canonical data is unlocked. In step 1216, the method of the present invention displays the canonical data and its originating source data. In step 1208, if the canonical data is not encrypted, the method of the present invention would display the canonical data and its originating source data in step 1216. Once the results are displayed, the process ends in step 1218. In step 1212, if no access is granted, the process ends at step 1218 and access is denied to the user. The user may repeat the steps are necessary to investigate each node in the path between the two nodes of interest.

Queries may involve identify certain connections that met a threshold. Queries may be performed on transactional connections and relationship connections. For example, a user may run a query to identify all transfers of fund that exceed $10,000. The highlighted connections in the inferential would represent the transactional connections that satisfy the query. Alternatively, a query may involve identifying all people who flew on the same flight. The highlighted connections in the inferential would represent the relationship connections that satisfy the query. Preferably, the query is performed in real time. In addition, the query may be set up for monitoring any changes in the nodes. Once a change does occur, the method of the present invention may alert the user to the change so that the user could investigate the changed node or connected vertices.

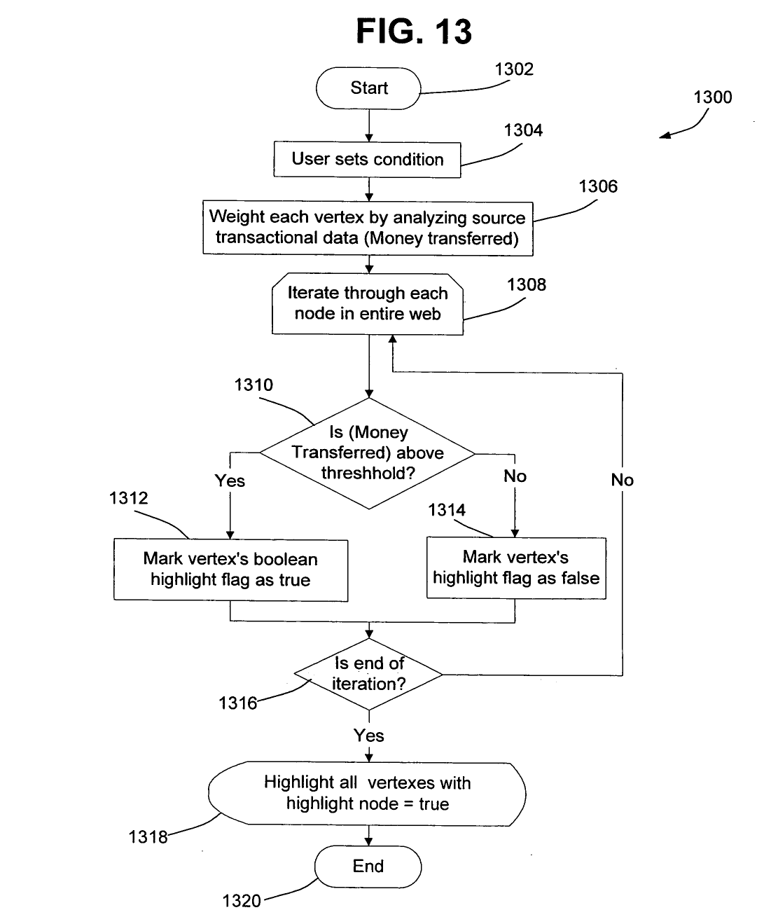

FIG. 13 is a flowchart of a query in inferential web such as shown in FIG. 9, according to a preferred embodiment of the method of the present invention. In process 1300 at step 1302, process 1300 is initiated by generating an inferential web. In step 1304, the user enters a desired condition or threshold that the user is investigating. The method filters the nodes that would apply to the threshold. In step 1306, the method of the present invention traverses the vertex's weight of a node to identify which vertices satisfy the threshold. The weighing is accomplished by investigating the canonical data of the node. In step 1308, the step 1306 is repeated for each node in the inferential web. In step 1310, the method of the present invention determines whether the weighed of the node satisfies the condition set in step 1304. If yes, in step 1312 both the connected vertices of the nodes will be flagged as true. If no, in step 1314 the connected vertices will be flagged as false. After step 1312 or step 1314, the method repeats the step 1310 for the remaining nodes in step 1316. If there are remaining iterations then step 1310 is repeated. In step 1316, if there are no remaining iterations, the method of the present invention will display all highlighted connections that are flagged as true in the inferential web in step 1318. The process ends in step 1320 and may be repeated for additional inferential webs.

A preferred query for identifying connections that meets a threshold may have filter for including certain types of information. For example, if the user runs the query to identify connections that exceed $10,000, the filter would include only information related to financial transactions. The method of the present invention would start with one node and traverse the vertices of that node. The method of the present invention may determine if any vertices represent a transfer that is greater than $10,000. When that threshold is met, the method labels the connection as true. This process is repeated for each node in the inferential web.

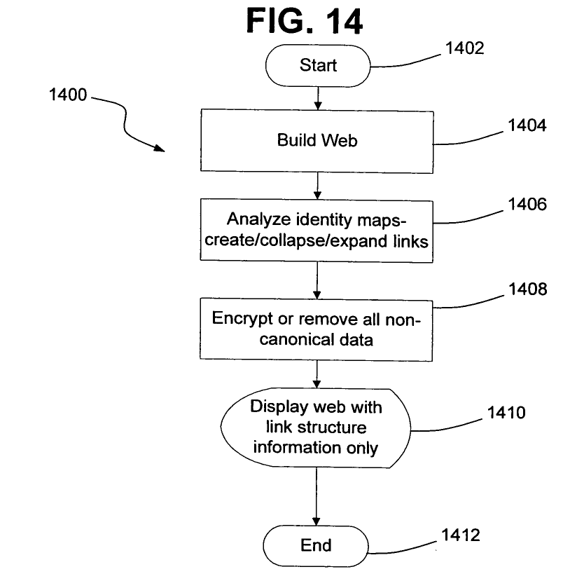

FIG. 14 is a flowchart illustrating the generation of connected vertices between nodes from different domains, according to a preferred embodiment of the method of the present invention. In process 1400 at step 1402, process 1400 begins by acquiring the originating source data from at least two different domain logs (not shown). The method of the present generates canonical data from the domain logs in step 1404. In step 1406, the method of the present invention analyzes the transaction and relationship connections between nodes and creates, expands or collapses vertices between nodes. In step 1408, the method of the present invention encrypts the underlying data. In step 1410, the method of the present invention connects the vertices between the nodes to form an inferential web and the inferential web is displayed to the user. In step 1414, the process ends and may be repeated for additional inferential webs, domain logs or canonical data.

Preferably, the information in canonical data may relate one or more entities across one or more domains. For example, a user may know a cell phone number A called cell number B, but not does not know that cell number B also is e-mail account C of person D. The inferential web mapping techniques or connection of vertices helps a user identify this type of relationship. In this example, the method of the present invention helps to show that A is referentially linked to D. The privacy/encryption feature shows that B and D may be related but that the exact nature of the relationship may not be known without having the required credentials to view the underlying data. A user may perform the analysis on the structure without having to access the underlying data.

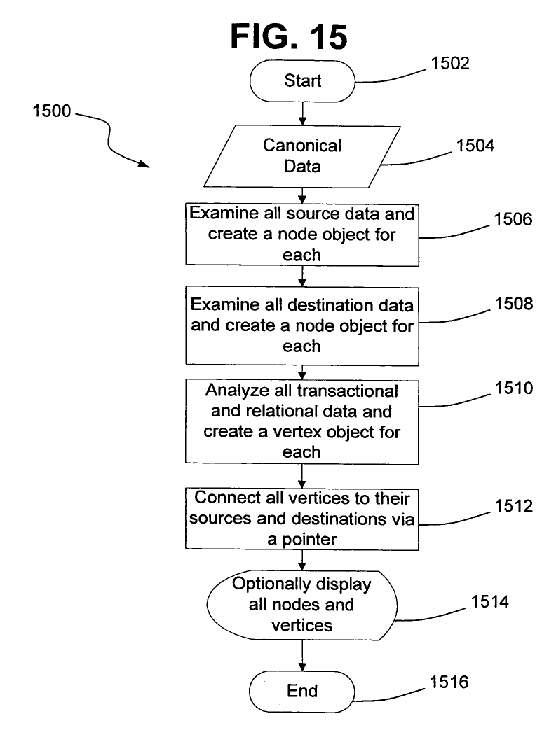

FIG. 15 is a flowchart of illustrating the generation of an inferential web having nodes and connected vertices from canonical data, according to a preferred embodiment of the method of the present invention. In process 1500 at step 1502, process 1500 begins by acquiring the originating source data from a domain log (not shown). The method of the present invention identifies common elements of the originating source data to create canonical data in step 1504. In step 1506, the method of the present invention examines the source data within the canonical data and creates a node. In step 1508, the method of the present invention examines the destination data within the canonical data and creates a node. In step 1510, the method of the present invention examines the transaction connection and relationship connection between the nodes and creates a vertex for each node. In step 1512, the method of the present invention connects the vertices between the source nodes and destination nodes using a pointer. After all nodes have been connected, an inferential web is formed. In step 1514, the inferential web is displayed to the user. The user may select certain nodes and vertices to display. In step 1516, the process ends and may be repeated for additional inferential webs.

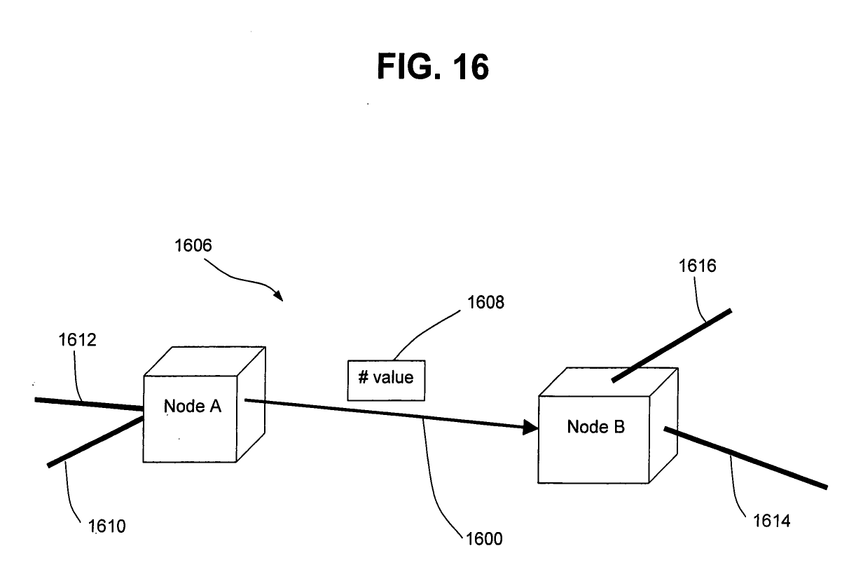

FIG. 16 illustrates a weighed vertex 1600 connecting node A and node B in an inferential web 1606, according to a preferred embodiment of the method of the present invention. Weighted vertex 1600 has a value 1608. Weighted vertex 1600 is a one-way vertex between node A and node B. Node A is connected by vertex 1610 and vertex 1612 to other nodes (not shown) in inferential web 1606. Node B is connected by vertex 1614 and vertex 1616 to other nodes (not shown) in inferential web 1606.

The weighed vertex between the nodes may be a transactional connection or a non-transaction connection. The weighed vertex may also be a multi-directional vertex. A node may have at least one vertex. Preferably, a node may have any number vertices depending on the parameters the user sets in creating the inferential web. The vertex may extent from a node in any direction to any other node within the inferential web.

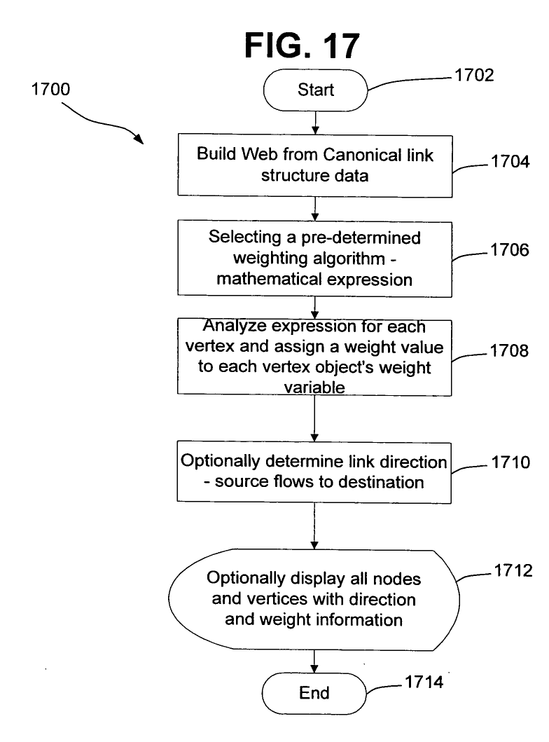

FIG. 17 is a flowchart illustrating a process of the present invention for creating weighed vertices between nodes in an inferential web, according to a preferred embodiment of the present invention. In process 1700 at step 1704, the originating source data from a domain log (not shown) is analyzed to form canonical data. In step 1706, nodes are built from the canonical data. The vertices assigned to each node are connected between the source and destination node to create an inferential web. In step 1708, the method of the present invention uses a weighting algorithm to determine weights of the vertices. In step 1710, the method of the present invention determines the direction of each vertex, such as one-direction or multi-directional, between the source node and the destination node. In step 1712, the method of the present invention displays the nodes and vertices between the nodes in an inferential web for the user to use. In step 1714, the process is ended and may be repeated for additional originating source data.

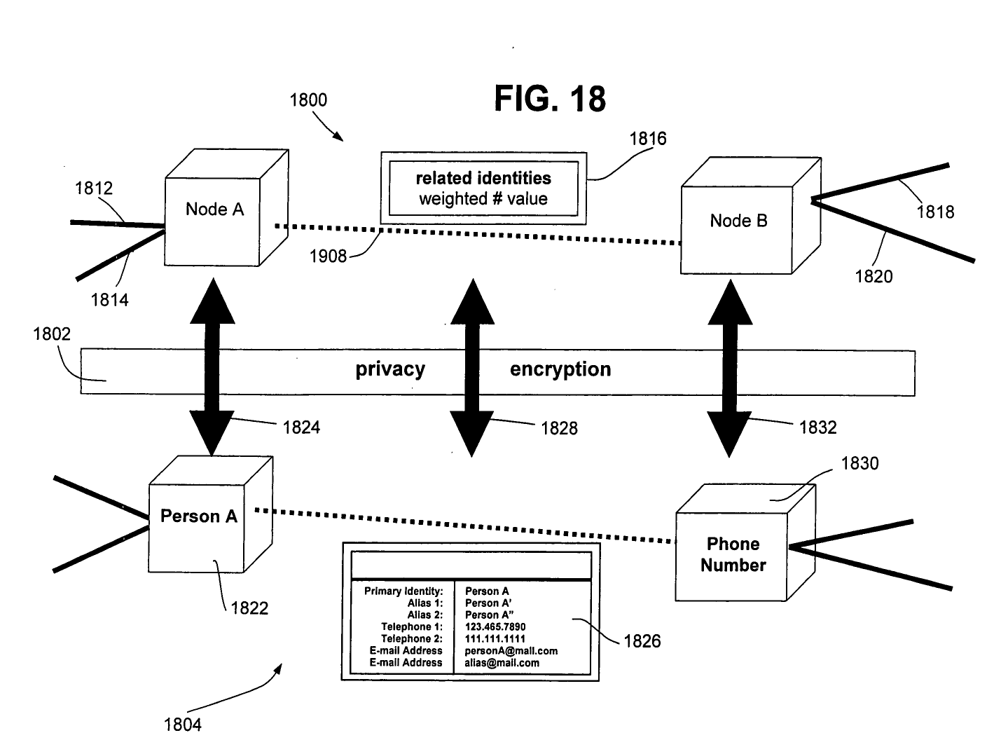

FIG. 18 illustrates an inferential web 1800 having an encryption protection 1802 that limits a user from viewing the underlying data 1804. The user may see on the display that node A is connected by a relationship vertex 1808 to node B. The user may monitor relationship vertex 1808 between node A and node B without knowledge of the underlying data 1804. Encryption 1802 prevents user from viewing the underlying data 1804 unless the user is properly authenticated. Node A is connected by vertex 1812 and vertex 1814 to other nodes not shown. Relationship vertex 1808 may be opened by a user to show a weighted value in a window 1816. Node B is connected by vertex 1818 and vertex 1820 to other nodes, not shown. Underlying data 1804 associated with node A is originating source data 1822. Originating source data 1822 would allow the user to determine that node A in inferential web 1800 is represented by person A. To access originating source data 1822, the user must meet the authentication requirements 1824. Underlying data 1804 associated with relationship vertex 1808 is an inferential identity table 1826. Inferential identity table 1826 allows the user to determine the type of relationship represented by relationship vertex 1808 between node A and node B. To access inferential identity table 1826, the user must meet the authentication requirements 1828. Underlying data 1804 associated with node B is originating source data 1830. Originating source data 1830 allows the user to determine that node B in inferential web 1800 corresponds to a telephone number. To access originating source data 1830, the user must meet authentication requirements 1832.

Because of the way the nodes may be constructed and arranged, the user can identify, analyze, and monitor the connections between entities without knowing or having access to the underlying detailed information, such as the originating source data. For example, the user may know a cell phone number A called cell number B, but not know that cell number B also is email account C and person D. The inferential web may show this unknown connection by showing that person A is referentially connected to person D.

In addition, at the same time the user is investigating links of the inferential web, the user credentials or security access can be established at the individual node and/or vertex level. This would allow the user to access certain underlying information for only certain nodes. The security access would allow two organizations to work together without disclosing proprietary information to the other. The credentials of each user may vary and may be changed dynamically.

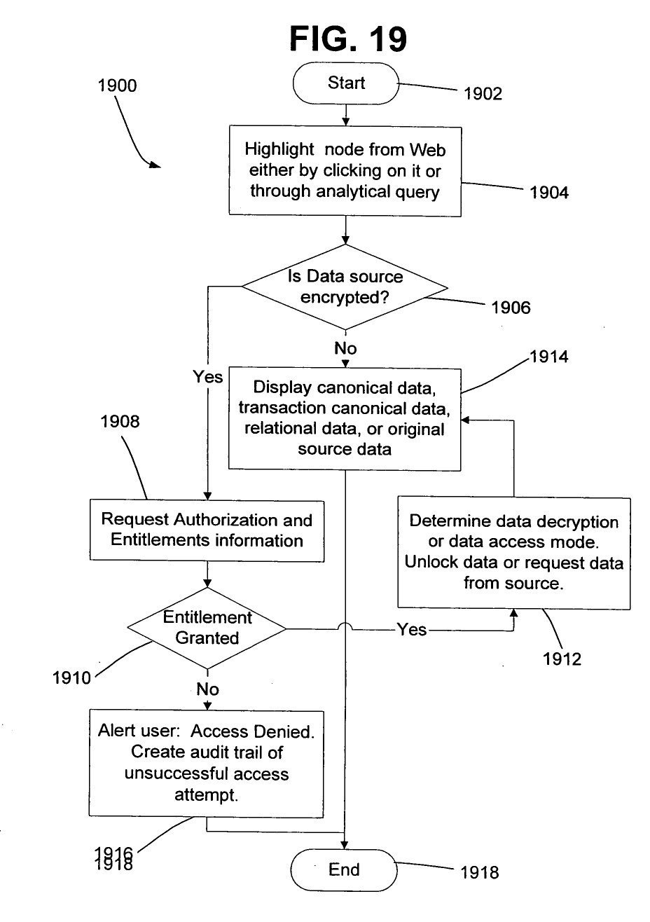

FIG. 19 is a flowchart of an encryption process, according to a preferred embodiment of the present invention. In process 1900 at step 1902, process 1900 begins with a completed inferential web already generated. In step 1904, the user selects a node to determine the underlying data. In step 1906, the method of the present invention determines whether the underlying data is encrypted. If the underlying data is encrypted, the user in step 1908 requests authorization. In step 1910, the method determines whether the credentials supplied by the user are entitled to view the underlying data. If the credentials met the encryption requirements, the underlying data is decrypted in step 1912. The user may view the underlying data in step 1914. If in step 1906, the data is not encrypted, the user may view the underlying data in step 1914. If in step 1910, the user does not have the credentials for access, in step 1916 the method of the present invention creates an alert condition and creates an audit trail of unsuccessful attempts to access encrypted data. In step 2016, the process ends and may be repeated to investigate additional nodes or vertices.

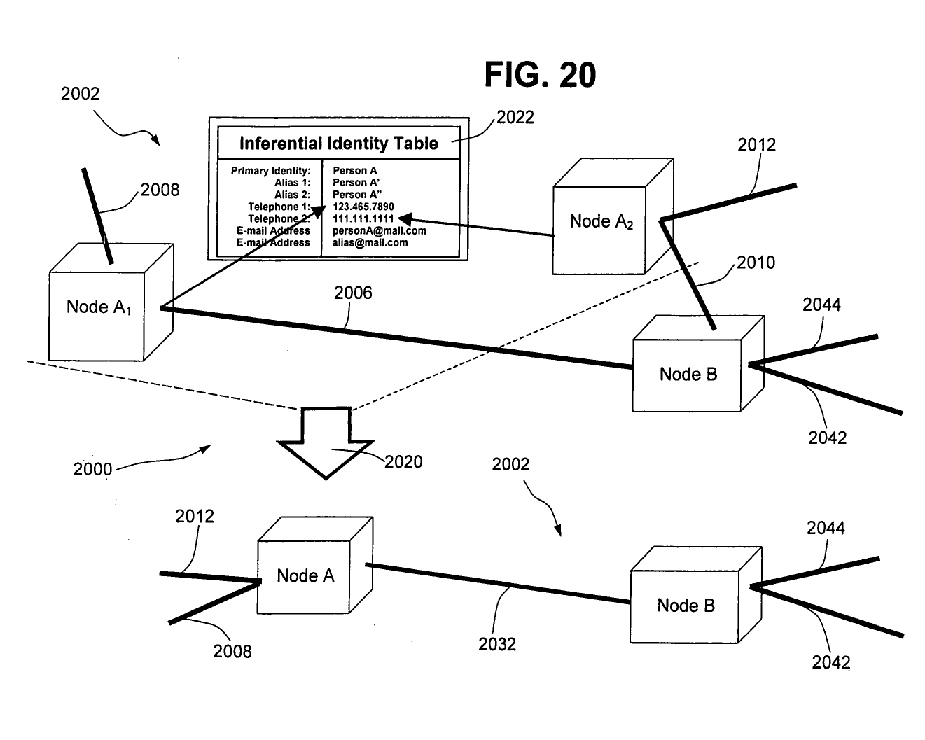

FIG. 20 is an illustration of collapsing operation 2000 of the present invention involving node A₁ and node A₂ in an inferential web 2002, according to a preferred embodiment of the present invention. Node A₁ is connected by vertex 2006 to node B and by vertex 2008 to another node, not shown. Node A₂ is connected by vertex 2010 to node B and by vertex 2012 to another node, not shown. Because a user has learned that a Person A goes by an alias A′, associated with node A₁ and an alias A″ associated with node A₂ a user collapses nodes A₁ and A₂ into a single node A as shown by arrow 2020. An inferential identity table 2022 shows the data that will be associated with node A including the Alias 1, Telephone Number 1, E-mail address persona@mail.com previously associated only with node A₁ and the Alias 2, Telephone Number 2, and e-mail address alias@mail.com previously only associated with node A₂. Collapsing nodes A₁ and A₂ into node A also results in vertices 2006 and 2010 collapsing into a new vertex 2032 connecting node A to node B. Also, both vertex 2008 and vertex 2012 are now connected to node A. Node B also includes two vertices 2042 and 2044 that connect to two other nodes not shown.

Although FIG. 20 illustrates a collapsing operation, the collapsing operation may be reversed by conducting an expansion operation which separates node A into node A₁ and node A₂. In addition, although FIG. 20 illustrates a situation in which nodes unconnected by vertices are collapsed into a single node, similar collapsing or expanding operations may be conducted on nodes connected by vertices.

As inferential webs and nodes are added and analyzed, or as more detailed originating source data is available, redundancy through the inferential web may occur. Similarly, while the nodes represent canonical data, there may be so many nodes that the inferential web becomes too complex to be properly investigated. Therefore, the method of the present invention may be programmed to have the ability to collapse nodes by commonality or relationship in the inferential identity table. Similarly, nodes previously identified as independent may be automatically collapsed into a single node once identified as the same entity, without losing any of the original data source from either node. Further, more than two nodes may be collapsed into a single node. For example, through an analysis of telephone logs, the user sees that Node A₁ and A₂ are actually the same entity. Therefore the two previously independent nodes can be collapsed into one.

Additionally, an inferential web may be collapsed into a node when combined with one or more inferential webs.

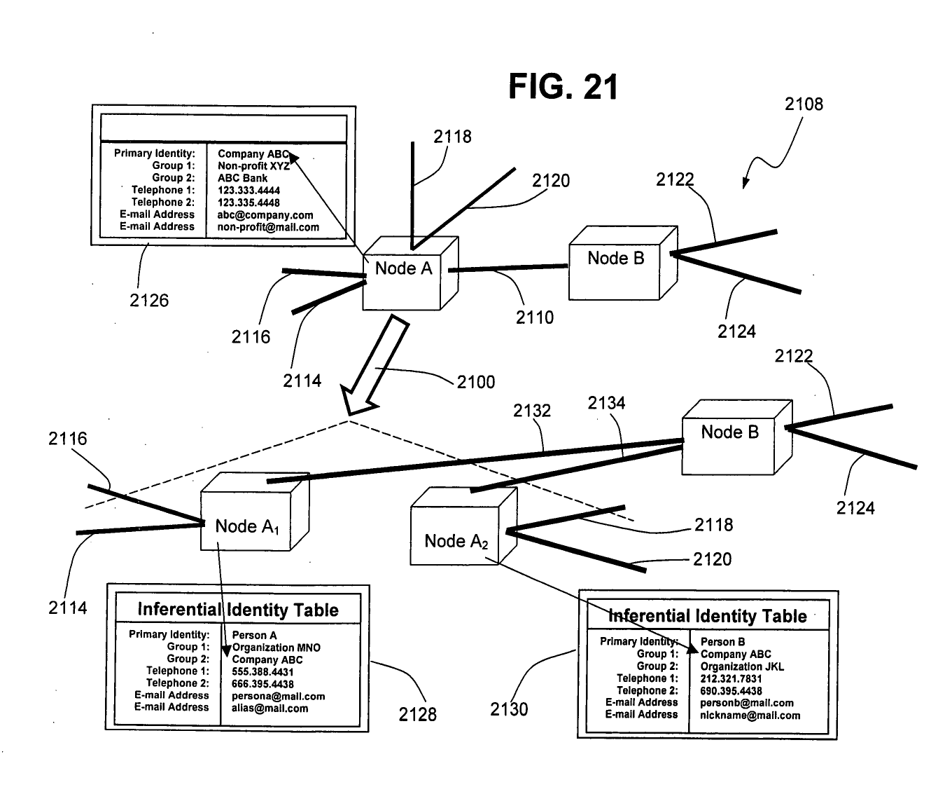

FIG. 21 is an illustration of an expansion operation 2100 of node A into a node A₁ and a node A₂ in an inferential web 2108, according to a preferred embodiment of the present invention. Node A is connected by vertex 2110 to node B. Node A is connected by vertex 2114, vertex 2116, vertex 2118, and vertex 2120 to other nodes, not shown. Node B is connected by vertex 2122 and vertex 2124 to other nodes not shown. An expansion operation 2100 is performed to separate Node A corresponding to a company ABC into node A₁ associated with Person A and node A₂ associated with Person B, both of whom work for company ABC. Identity table 2126 is associated with node A, identity table 2128 is associated with node A₁, and identity table 2130 is associated with node A₂. During expansion process 2100, vertex 2110 is expanded into vertex 2132 connecting Node A₁ to node B and vertex 2134 connecting node A₂ to node B.

As can be seen in FIG. 21, each node preferably has a primary identity and may be associated with one or more groups, one or more telephone numbers, and one or more e-mail addresses. Also, although FIG. 21 illustrates an expansion process, nodes A₁ and A₂ may be collapsed into node A by a collapsing process that reverses the expansion process.

The construction and arrangement of the inferential web may allow a user to expand a certain node to show greater detail or more specific analysis or monitoring. A node that contains information related to an entity may be expanded out into its smaller components. For example, the entity identified as node A in FIG. 21 consists of two smaller components identified as node A₁ and node A₂.

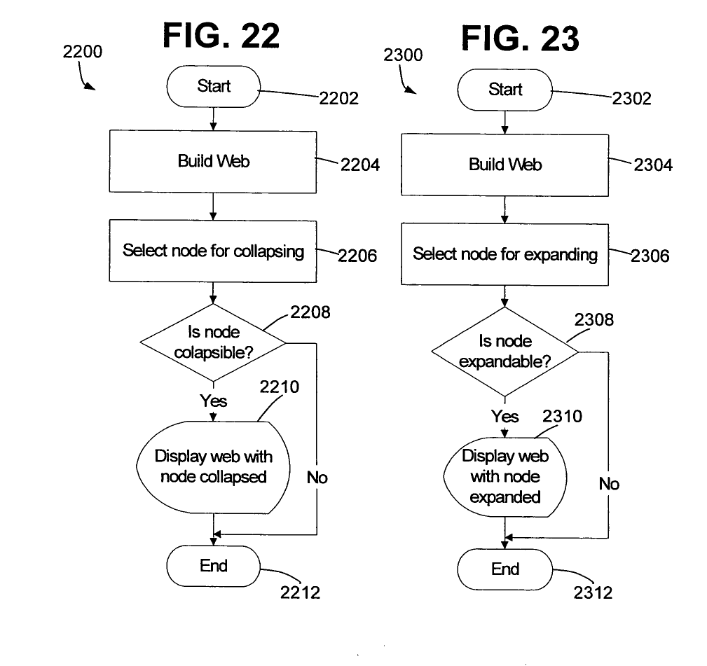

FIG. 22 is a flowchart of a collapsing operation according to a preferred embodiment of the present invention. In process 2200 at step 2202, originating source data is put into canonical form and then normalized to create nodes. In step 2204, the inferential web is generated with vertices between nodes. In step 2206, the method of the present identifies nodes that may be selected for collapsing because two or more nodes share common elements. In step 2208, the method determines if the node is collapsible. If the node is collapsible in step 2210, the resulting inferential web with the collapsed node is displayed for the user. If in step 2208, the node is not collapsible, then the process ends in step 2212. The process may be repeated for additional collapsible nodes by returning to step 2208.

FIG. 23 is a flowchart of an expanding operation according to a preferred embodiment of the present invention. In process 2300 at step 2302, originating source data is put into canonical form and then normalized to create nodes. In step 2304, the inferential web is generated with vertices between nodes. In step 2306, the method of the present invention identifies nodes that may be selected for expansion because one entity node has two or more nodes share common elements with the entity node. In step 2308, the method determines if the node is expandable. If the node is expandable in step 2310, the resulting inferential web with the expandable node is displayed for the user. If in step 2308, the node is not expandable, then the process ends in step 2312. The process may be repeated for additional expandable nodes by returning to step 2308.

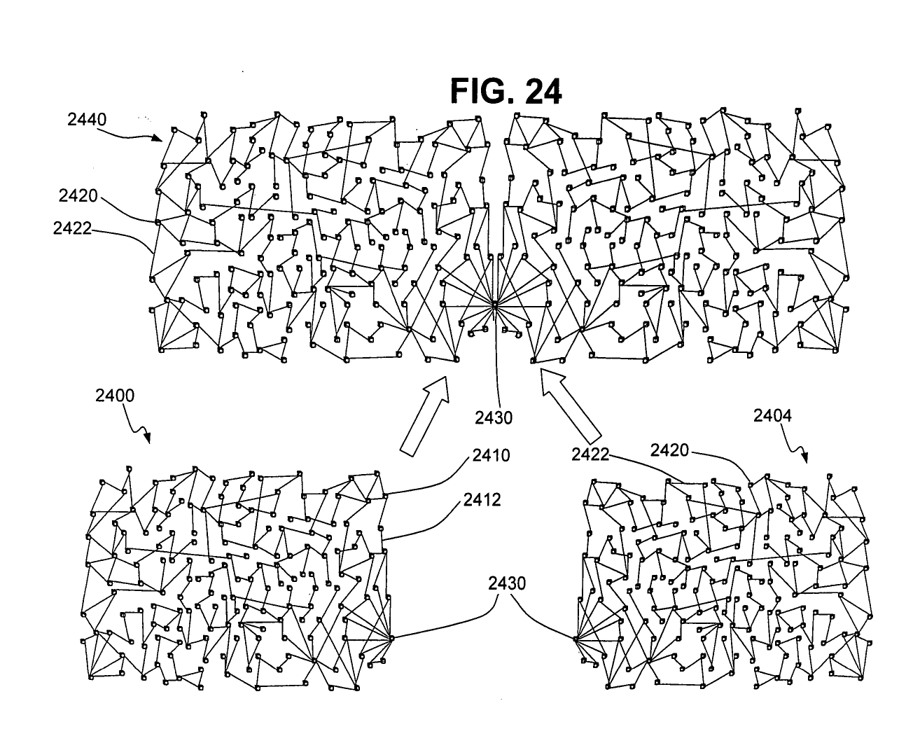

FIG. 24 illustrates the combination of an e-mail log inferential web 2400 with a financial transaction log inferential web 2404, according to a preferred embodiment of the present invention. Inferential web 2400 has nodes 2410 and vertices 2412 that connect the nodes 2410. Inferential web 2404 has nodes 2420 and vertices 2422 that connect the nodes 2420. Inferential web 2400 and inferential web 2404 have a common node 2430. Common node 2430 allows inferential web 2402 and inferential web 2404 to be combined at node 2430 to form a combined inferential web 2440. Combined inferential web 2440 has nodes 2442 and vertices 2444.

By reversing the combination process shown in FIG. 24, two inferential webs may be extracted from the combined inferential web.

Due to the construction and arrangement of the inferential webs, nodes and data from one inferential web can be “shared” or combined with other inferential webs to create a new inferential web. Any number of inferential webs may be combined. The combination may allow a user to identify, analyze, and monitor the connections among, across and between entities, and nodes common to both inferential webs would be combined.

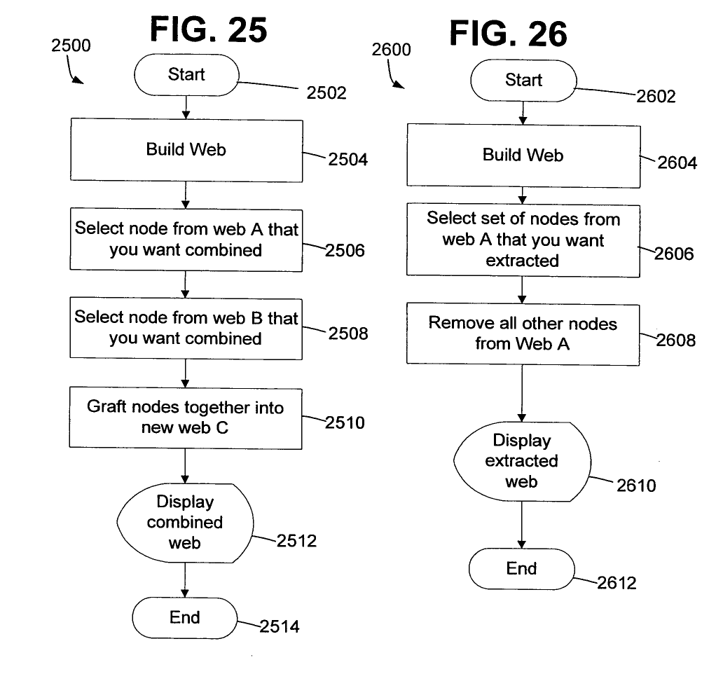

FIG. 25 is a flowchart of an inferential web combination process according to a preferred embodiment of the present invention. In process 2500 at step 2502, originating source data is put into canonical form and then normalized to create nodes for at least two domains. In step 2504, the at least two inferential webs are generated with vertices between nodes. In step 2506, the user selects one inferential web. In step 2508, the user selects a second inferential web. In step 2510, the method of the present invention grafts or combines the selected inferential webs in step 2506 and 2508. In step 2512, the method of the present invention displays the new combined inferential web to the user on a display. In step 2514, the process is ended and may be repeated by returning to step 2506 to add addition inferential webs.

Alternatively, in FIG. 25, a user may select certain nodes from at least two inferential webs, without selecting all the nodes within an entire inferential web, to combine in a new inferential web. This allows the user to investigate nodes of interest in multiple inferential webs to determine if additional vertex exists in the new inferential web.

FIG. 26 is a flowchart of an extraction operation according to a preferred embodiment of the present invention. In process 2600 at step 2602, originating source data is put into canonical form and then normalized to create nodes. In step 2604, the inferential web is generated with vertices between nodes. In step 2606, the user may select nodes to extract the inferential web. In step 2608, the method of the present invention removes all the non-select nodes from the inferential web. In step 2610, the method of the present invention displays the extracted set of nodes. In step 2612, the process is ended and may be repeated by returning to step 2606 to extract additional nodes.

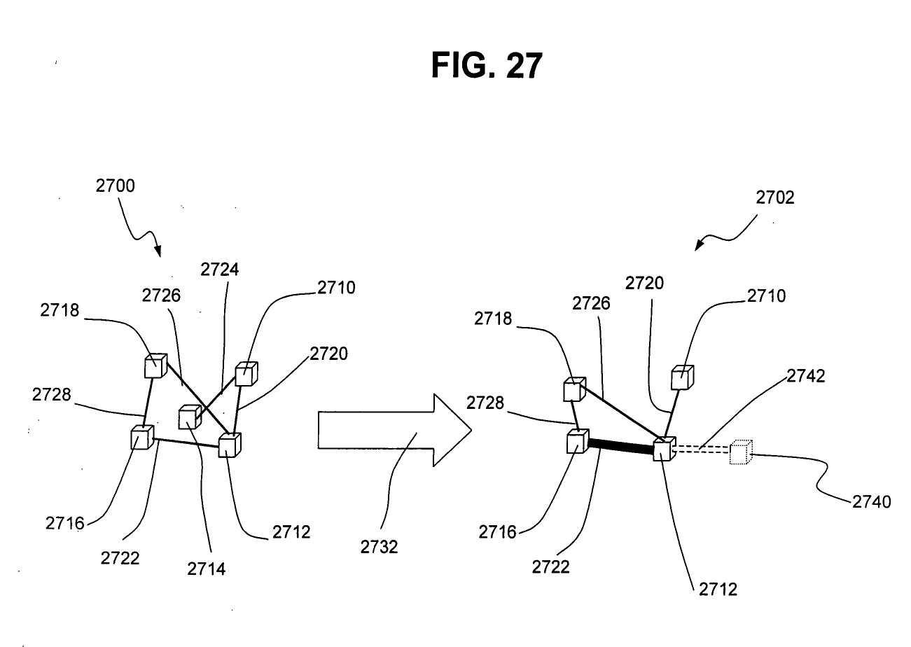

FIG. 27 illustrates the operation of a query that causes a portion of an inferential web 2700 of the present invention to be modified to form a modified inferential web 2702. Inferential web 2700 includes a node 2710, a node 2712, a node 2714, a node 2716, and a node 2718. Node 2710 is connected by vertex 2720 with node 2712. Node 2712 is connected by vertex 2722 with node 2716. Node 2710 is connected by vertex 2724 with node 2714. Node 2712 is connected by bidirectional vertex 2726 with node 2718. Node 2716 is connected by vertex 2728 with node 2718. A user submits a query for the method of the present invention to process at arrow 2730. After the query is complete, the method of the present invention displays and stores a modified inferential web 2702. In inferential web 2702, vertex 2720 still connects node 2710 and 2712 after the query is made. Vertex 2722 connecting node 2172 and node 2714 is thicker after the query is made indicating that the weight of vertex 2722 has been increase. Vertex 2724 is deleted after the query is made because node 2714 was deleted. The direction of connected vertex 2726 was altered after the query from being bidirectional to being directed from node 2718 to node 2712. After the query is made a new node 2740 is created connected by vertex 2742 with node 2412.

It should be appreciated that the results of a query may add, alter, or delete new nodes, vertices, inferential webs, domain logs, and/or canonical data. The results may be applied once or may be applied continuously to monitor changes in the inferential web.

Preferably, a query concerning the relationships between entities may generate additional connections. The identification of connectivity, then, leads to redefinitions of the relationships allowing the method of the present invention to be dynamic and governed by the data construction as much as by the user's queries.

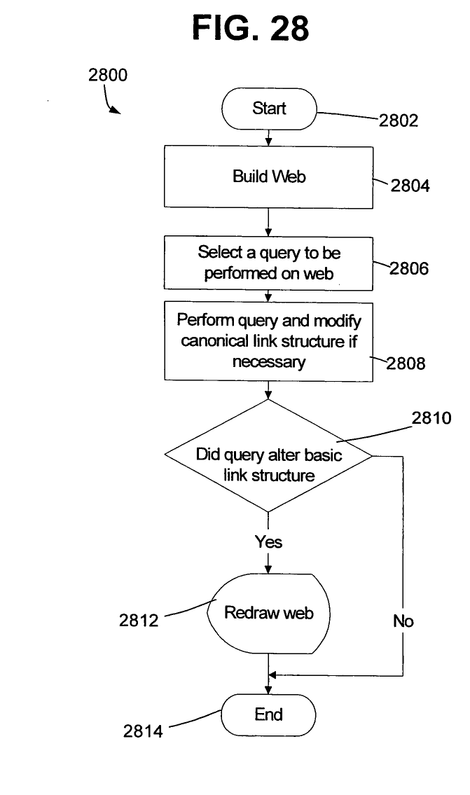

FIG. 28 is a flowchart of a query performed on an inferential web according to a preferred embodiment of the present invention. In process 2800 at step 2802, originating source data is put into canonical form and then normalized to create nodes. In step 2804, the inferential web is generated with vertices between nodes. In step 2806, the user may select a query to be performed. In step 2808, the method of the present invention performs the query and modifies the nodes and/or the vertices between nodes that are impacted by the query. In step 2810, the method of the present invention decides whether the query altered the basic node/vertex structure of the present invention. If the query altered the basic node/vertex structure, in step 2812 the inferential web is redrawn with the modified nodes/vertices. After the method of the present invention displays the modified inferential web the process ends at step 2814 and may be repeating at step 2806 if another query is performed. If in step 2812 the query did not alter the basic node/vertex structure, then the process in step 2814 is ended and may be repeated at step 2806 if another query is performed.

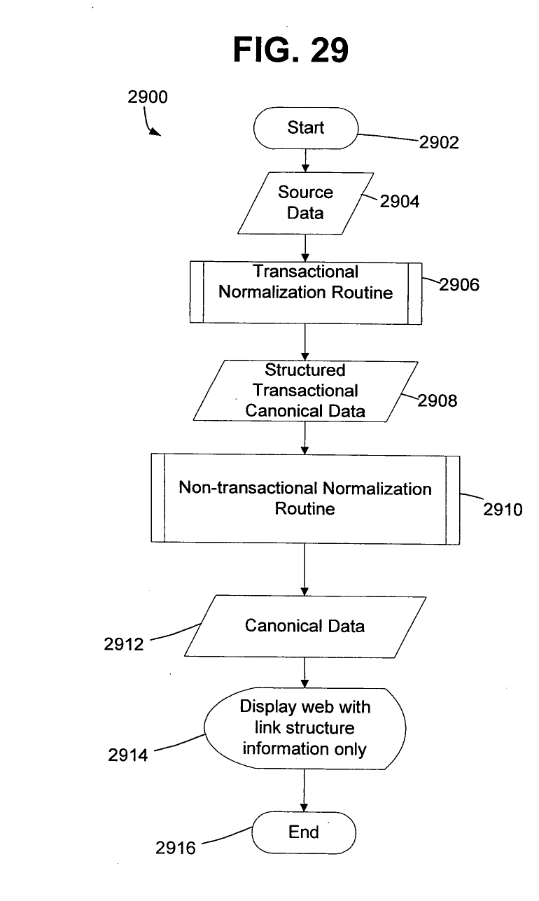

FIG. 29 is a flowchart illustrating a process 2900 of identifying data relationship, according to a preferred embodiment of the present invention. Process 2900 begins in step 2902 by selecting a domain log, such as financial, e-mail, telephone call, etc. In step 2904 the originating source data from the domain log is pulled from its original source. In step 2906, the method of the present invention normalizes the originating source data to generate transactional connections of vertices between nodes. In step 2908, the normalization process creates transactional canonical data. In step 2910, the method of the present invention normalizes inferential relationship data to generate relationship connections of vertices between nodes. In step 2912, the normalization process creates transactional canonical data. In step 2914, the link structure is displayed and stored on an optical disk for the user to analyze. In step 2916, the process is ended and may be repeated for the addition of domains or originating source data.

It should be appreciated that when an inferential web is displayed by the method of the present invention, the user may also store the inferential web on an optical storage disk.

Preferably, the method of the present invention reduces the originating source data into canonical data that may be linked using transactional and relationship connections between at least two nodes. A preferred inferential web may have connected vertices that represent transactional connections and inferential relationship connections.

A preferred subroutine for analyzing the data for inferential related associations, may incorporate external data sources such as alias tables, group attendance records, religious affiliations, country of origin, etc. to establish the inferential connected vertices between nodes.

The method of the present invention may use pre-defined mapping techniques to translate the originating source data into canonical data.

The method of the present invention provides a next generation data analysis technology that to solve these problems. One important feature of the method of the present invention is the ability of the method to be used to identify and analyze complex relationships, both within and across complex organizations and industries. Because of the unique science embedded in the method of the present invention, access to the information necessary to track suspicious activities across multiple industries can be accomplished while assuring consumer privacy.

Something as simple as a financial transaction carries far more information than current software solutions reveal. Much information can be gleaned from transaction data, whether that transaction is a financial transaction, e-mail, shipped package, phone call, or transportation log. All of these transactions carry the same types of vital information: an owner, a source, a destination, a time, as well as other supporting information. By connecting all of this data together with the right technology platform, law enforcement officials and private sector can pull threads of critical information from a seaming tangle of confusion. The method of the present invention will also answer questions about geographic patterns, direct and indirect relationships and associations, and probable actions from that same transaction. The strategy of the present invention is to use current data that exists and minimizes the need for additional government policy, regulation, and legislative changes to gather new data to establish an effective illicit activities monitoring system.

The next generation monitoring system of the present invention must also be able to simultaneously and seamlessly span across multiple organizational databases. The solution must not require data replication; rather data must be shared across existing technical platforms while maintaining the necessary security protocols surrounding sensitive information. At the same time, such a solution must be flexible enough to input intelligence into the system; in other words, the query logic must be able to be directed by and learn from the experience of those tasked with garnering intelligence.

Once a disaster occurs, a user may want to use the method of the present invention to untangle a bundle of information to determine who and/or what was involved. The method of the present invention may be able to perform this retroactive analysis. However, even more important is the ability to proactively send alerts regarding suspicious activities before disasters strike. The method of the present invention may be able to proactively scan information looking for dangerous activity is critical to security.

In one preferred embodiment, the method of the present invention looks at a transaction log not a series of payments but as a roadmap of potential relationships. Advanced analysis of these relationships may allow a user to uncover suspicious activities of individuals or groups. Transaction logs may share common data elements with other point-to-point domains. A transaction may involve an owner, a timestamp, a source, a destination, and content. This same framework may also apply to emails, phone calls, airline travel, UPS packages, etc. Preferably the method of analyzing referential and inferential relationships within data can be applied to a single domain or across multiple domains.

The method of the present invention looks at those transaction logs not as a series of payments or phone calls but as a roadmap of potential relationships. Advanced analysis of these relationships allows the uncovering of suspicious rings or cells of activity.

The method of the present invention decomposes the data sources into this simple common data element framework, called canonical form. The data is normalized or standardized into a relational roadmap. Several different types of conventional methods, e.g. social network analysis, complexity theory, modern graph theory, inferential statistics, data visualization, etc., may be applied analyze that information.

The method of the present invention first shapes the data into a connected set of referential relationships. Referential refers to a direct mapping of source and destination. These relationships may be expanded to capture inferential relationships. An example of an inferential relationship would be if John sends an email to Mary and Mary sends an email to Jane, then there is a referential relationship between John and Mary, and an inferred relationship between John and Jane. The end result is referred to as an inferential web. Each connected edge of the web has a weighted value that indicates the strength of the inferential relationship with regards to the source vertex. The inferential multivariate-analysis engine allows these weights to be programmatically assigned, mapped, and evaluated.

The method of the present invention allows the decomposition of these data sources into this simple elemental framework. The data is normalized into a relational roadmap. Several different types of conventional methods, e.g. a proprietary rules engines, neural network analysis, genetic algorithms, modern graphing theory, inferential statistical analyses, etc., may be applied to analyze the information.

The method of the present invention shapes the inputted data into a connected set of referential relationships. Referential refers to a direct mapping of source and destination. These relationships may be expanded to capture inferential associations. The end result is an inferential web. Each connected edge of the inferential web may have a weighted value that indicates the strength of the inferential relationship with regards to the source vertex. The method of the present invention may allow these weights to be programmatically assigned, mapped, and evaluated.

After the weights have been programmatically assigned, mapped, and evaluated, an overlay may be placed over the web to identify suspect individuals or groups. This dynamic tool allows organizations and governments to extract relationship subsets with current information and without violating current privacy laws. These extractions may be for suspicious activity tracking; group identification and monitoring; and the tracking and monitoring of individuals, e.g. foreign students, individuals on the OFAC list, etc. Users may access and monitor known suspects, identify associations with other individuals and organizations without necessarily accessing specific information.

The method of the present invention is built on a web-enabled open architecture that can be seamlessly integrated and co-exist within an existing technology environment. It offers a high degree of scalability, availability, security and portability.

In addition, the method of the present invention safeguards the privacy of people and protects inter- and intra-organization sensitive information. Each node or vertex in an inferential web may be encrypted and would require user authentication before permitting access to the underlying data. This may allow two or more organizations to work together without disclosing sensitive information using a blind encryption method. When one organization determines that a particular pattern of activity is suspicious, it can obtain access to a particular node within the inferential web. The entity that “owns” that node, when presented with appropriate authorization, can immediately upload the relevant data for that node. Certain common data elements such as suspicious individuals on an OFAC or FBI list, can be automatically “decrypted,” identified and proactively tracked within the inferential web structure. These common data elements may also be electronically shared across separate inferential webs operated by different organizations.

Data analysis among and between various agencies can be accomplished without replication of databases. Additionally, relationships between individuals, networks and organizations can be identified and monitored without necessarily sharing detailed or agency-specific sensitive information. The massive data sets that are available for analysis may contain millions of records. The method of the present invention does not require single massive database. Link structure analysis can be performed on a reduced canonical set of data. Links to source information can be embedded within the schema. These links can be used to traverse into the original source databases when necessary.

The method of the present invention is able to handle the fact that terrorist networks consist of cells of individuals who communicate infrequently and who share minimally necessary information. Communication amongst these individuals may be through multiple channels: email, cell phone, telephone, electronic newsgroups and postal mail. These individuals have also been identified by limited financial transactions between its members. Massive data sets exist that have significant information regarding these communications and financial transactions. Organizational data may also be available that identifies individuals as being members of multiple and potentially overlapping groups. Analysis of these disparate data sets is extremely complex and cumbersome. Traditional algorithms based solely on data mining have proved ineffective or are limited in their ability to analyze overlapping organizations with intermediate structures. To identify, track and preempt illegal activities of these organizations requires applying new technologies and developing new algorithms to answer critical questions about their structure and behaviors.

Using the method of the present invention, an analysis does not have to be performed on the entire data set. Instead, the data sets may be reduced to an elemental framework that provides the building blocks for a complex link structure analysis. Method of the present invention's normalization algorithms will reduce this information to a unique canonical form that describes the basic link structure inherent in all of these data sets. Traditional clustered data mining can be applied to recognize small world architectures. Data structures may be developed that can store these large inferential webs for a quick, scalable analyses. Query languages maybe developed that facilitate the traversal of these webs and allow “man in the loop” intelligence. Social network analysis algorithms can analyze the link structure. The analysis can identify the existence and structure of these organizations. Referential and statistical mapping techniques can take known organizational information and augment the existing link structure information. Patterns of behaviors within these organizations may create identifiable signatures that can be correlated across massive data sets. This correlation may be able to proactively identify the existence of previously unknown nefarious organizations. One important advantage of the analysis method of present invention is the ability to pull data from diverse and massive data sources. First reducing the data into a manageable form, then performing analysis. The method of the present invention may be architected to proactively protect individual privacy and inter-agency security protocols. Only the identities of those people that are under an authorized investigation need to be visible. However, if a particular “blind” node should be the basis for additional investigation, then access can be sought and its identity revealed.

The analysis method of the present invention may allow private firms and agencies to analyze their own data for suspicious activities while also quickly and easily complying with broader requests for information, without compromising individual privacy or sector specific security protocols. Secure businesses help create a secure country.

The analysis method of the present invention may be employed to place a minimal technology burden upon agencies and firms that employ the method. The method of the present invention may work in concert with existing database solutions, allowing organizations to leverage previous technology investments and thereby minimize the impact. Although firms have the ability to deploy a full analytic capability within their firewalls, the only technology that it is important they deploy in order to access data from or comply with the requests of an inferential web of the present invention is a relatively simple normalization layer.

The present invention may be used in a variety of fields in which pattern recognition and data relationship analysis are important, such as: medical diagnoses, biological categorization, financial market prediction, credit card fraud detection, retail transactions, insurance applications, criminal investigation, security background checks, utility distribution systems for electricity, water, gas, etc., traffic control for highways, sea lanes, etc., assigning flight patterns, package shipping, communication networks for telephone, e-mail, cell phones, cable television, video on demand, etc., computer networks, distributions for entrainment tickets, mass mailings, etc., travel related reservation system for airline tickets, hotel reservations, rental car reservations, etc., manufacturing process, inventory tracking and control, rail networks, personal identification, etc.

### EXAMPLE 1

Primitas™ software is used to generate an inferential web using nodes and vertices based on the canonical data. A user runs the following query on the inferential web: “What are all the relationships between Fred Smith and Jane Doe?”

The software traverses the inferential web for any and all associations between the nodes of interest. If an association exists, the software would return the relationship web of all those associations, i.e. nodes, between the nodes of interest. Each node is analyzed to determine the potential for additional investigations.

### EXAMPLE 2

Primitas™ software is used to generate an inferential web using nodes and vertices based on the canonical data. A user runs the following query on the inferential web: “What are the all connections related to Fred Smith or any alias within five levels?”

Primitas™ generates a web that includes all accounts that Mr. Smith touched including the webs that touched them, enabling the identification of all associates, whether individuals or organizations.

### EXAMPLE 3

Primitas™ software is used to generate an inferential web using nodes and vertices based on the canonical data. A user runs the following query on the inferential web: “What are all the accounts related to Jane Doe or any alias within the financial domain that are less than 10 levels deep where the Total Transfer Amount was greater than $10,000?”

Primitas™ generates a web containing only the accounts where $10,000 has been transferred between them, even if small amounts had been transferred between multiple nodes (e.g. structuring).

### EXAMPLE 4

Primitas™ software is used to generate an inferential web using nodes and vertices based on the canonical data. A user runs the following query on the inferential web: “What are the airline flights related to any individual having telephone contact with Jane Doe?”

Primitas™ generates a web containing paths that link any individual believed to be associated with Ms. Doe and their travel history or plans.

### EXAMPLE 5

Primitas™ software is used to generate an inferential web using nodes and vertices based on the canonical data. A user runs the following query on the inferential web: “What is the intersection of financial accounts related to airline travel involving Hamburg, Germany during the period from Jan. 1, 2001 to Jan. 1, 2002 AND e-mails sent from the domain happylandfoundation.com?”

Primitas™ generates a web containing only accounts that have a reasonable connection to both travel to or from Germany and e-mails from a suspect Internet domain.

### EXAMPLE 6

Primitas™ software is used to generate an inferential web using nodes and vertices based on the canonical data. A user runs the following query on the inferential web: “From whom and where are the dollars coming to fund the efforts of Fred Smith and his associates?”

Primitas™ generates a web identifying the relationships between Mr. Smith and any associates and then identify the funding sources for this network.

### EXAMPLE 7

Primitas™ software is used to generate an inferential web using nodes and vertices based on the canonical data. A user runs the following query on the inferential web: “What other relationships exist that follow a similar pattern to relationships between known criminals?”

Primitas™ creates webs for known offenders. Primitas™ then uses PRIMEngine™ a software product made by the Primiter Group employing the analysis method of the present invention, to identify other webs that have a similar fingerprint.

### EXAMPLE 8

Primitas™ software is used to generate an inferential web using nodes and vertices based on the canonical data. A user runs the following query on the inferential web: “Alert me to any new relationships that form between known suspects.”

Primitas™ regularly monitors the inferential web for any activity or new associations formed by the suspects. The activity may be non-obvious, spanning e-mails, financial transfers, phone calls, and other networks.

### EXAMPLE 9

Primitas™ software is used to generate an inferential web using nodes and vertices based on the canonical data. A user runs on the inferential web: “Alert me to any potential relationships that follow a similar pattern to a relationship between known criminals.”

Primitas™ regularly monitors the inferential webs for any sub-webs that have a similar fingerprint to known offenders.

### EXAMPLE 10

Primitas™ software is used to generate an inferential web using nodes and vertices based on the canonical data. A user runs on the inferential web: “Alert me to any expenditures by the Happyland Foundation or any members or associates for any suspect purchase (e.g. flying lessons, precursor chemicals, etc.)

Primitas™ generates an inferential web identifying all associations to the Happyland Foundation and regularly monitor that web for suspect purchases.

All documents, patents, journal articles and other materials cited in the present application are hereby incorporated by reference.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A method for identifying data relationships comprising the steps of:
(a) providing source data; and
(b) reducing said data into canonical data, said canonical data being capable of being used in an inferential web that shows a user connections between at least two entities.

2. The method of claim 1, wherein said method further comprises the step of displaying said canonical data to a user on a visual display apparatus.

3. The method of claim 1, wherein said method further comprises the step of storing said canonical data on a data storage medium.

4. The method of claim 1, wherein said canonical data comprises transactional canonical data.

5. The method of claim 4, wherein each of said transactional canonical data comprises no more than 3 transactional canonical data elements.

6. The method of claim 4, wherein said canonical data comprises relationship canonical data.

7. The method of claim 1, wherein said canonical data comprises relationship canonical data.

8. The method of claim 1, wherein said method is implemented in a computer system.

9. A method for structuring data comprising the steps of:
(a) providing a plurality of canonical data; and
(b) organizing said canonical data into an inferential web comprising a plurality of nodes and at least one vertex connecting at least two connected nodes of said plurality of nodes, wherein said inferential web shows a user connections between a plurality of entities.

10. The method of claim 9, wherein said method further comprises the step of displaying said inferential web to a user on a visual display apparatus.

11. The method of claim 9, wherein said method further comprises the step of storing said inferential web on a data storage medium.

12. The method of claim 9, wherein said canonical data is structured into said inferential web based on a plurality of connections present in said plurality of canonical data.

13. The method of claim 9, wherein said method further comprises the step of assigning weight to said at least one vertex.

14. The method of claim 9, wherein said method further comprises the step of assigning a direction to said at least one vertex.

15. The method of claim 9, wherein said canonical data comprises transactional canonical data.

16. The method of claim 15, wherein each of said transactional canonical data comprises no more than 3 transactional canonical data elements.

17. The method of claim 15, wherein said canonical data comprises relationship canonical data.

18. The method of claim 9, wherein said canonical data comprises relationship canonical data.

19. The method of claim 9, wherein said method is implemented in a computer system.

20. A data structure comprising:
canonical data, said canonical data being organized into a plurality of nodes and at least one vertex connecting at least two connected nodes of said plurality of nodes, wherein said data structure comprises an inferential web that shows a user connections between at least two entities.

21. The data structure of claim 20, wherein said inferential web is displayed to a user on a visual display apparatus.

22. The data structure of claim 20, wherein said inferential web is stored in a data storage medium.

23. The data structure of claim 20, wherein at least some of said nodes are secure nodes.

24. The data structure of claim 20, wherein said data structure is collapsible.

25. The data structure of claim 20, wherein said data structure is expandable.

26. The data structure of claim 20, wherein said data structure is combinable.

27. The data structure of claim 20, wherein said data structure is extractable.

28. The data structure of claim 20, wherein said at least two connected nodes comprises a plurality of connected nodes.

29. The data structure of claim 20, wherein said at least one vertex comprises a plurality of vertices.

30. The data structure of claim 29, wherein at least some of said plurality of vertices are weighted vertices.

31. The data structure of claim 30, wherein at least some of said weighted vertices are dynamically weighted vertices.

32. The data structure of claim 29, wherein at least some of said plurality of vertices are directional vertices.

33. The data structure of claim 20, wherein said canonical data comprises transactional canonical data.

34. The data structure of claim 33, wherein each of said transactional canonical data comprises no more than 3 transactional canonical data elements.

35. The data structure of claim 33, wherein said canonical data comprises relationship canonical data.

36. The data structure of claim 20, wherein said canonical data comprises relationship canonical data.

37. The data structure of claim 20, wherein said data structure is located in a computer system.

38. The data structure of claim 20, wherein said data structure is located on a data storage medium.

39. A method of modifying a data structure comprising the steps of:
(a) providing an inferential web comprising canonical data, said canonical data being organized into a plurality of nodes and at least one vertex connecting at least two connected nodes of said nodes, wherein said data structure comprises an inferential web that shows a user connections between at least two entities; and
(b) modifying said inferential web to form a modified inferential web.

40. The method of claim 39, wherein said method further comprises the step of displaying said modified inferential web to a user on a visual display apparatus.

41. The method of claim 39, wherein said method further comprises the step of storing said modified inferential web on a data storage medium.

42. The method of claim 39, wherein step (b) comprises assigning a weight to said at least one vertex.

43. The method of claim 39, wherein step (b) comprises modifying a weight of said at least one vertex.

44. The method of claim 39, wherein step (b) comprises assigning a direction to said at least one vertex.

45. The method of claim 39, wherein step (b) comprises modifying a direction of said at least one vertex.

46. The method of claim 39, wherein step (b) comprises collapsing at least a portion of said inferential web.

47. The method of claim 39, wherein step (b) comprises expanding at least a portion of said inferential web.

48. The method of claim 39, wherein step (b) comprises combining at least a portion of said inferential web with a second inferential web.

49. The method of claim 39, wherein step (b) comprises extracting at least a portion of said inferential web,

50. The method of claim 39, wherein at least some of said nodes are secure nodes.

51. The method of claim 39, wherein said at least two connected nodes comprises a plurality of connected nodes.

52. The method of claim 39, wherein said at least one vertex comprises a plurality of vertices.

53. The method of claim 39, wherein said inferential web is modified due to said inferential web being queried by said user.

54. The method of claim 39, wherein said canonical data comprises transactional canonical data.

55. The method of claim 54, wherein each of said transactional canonical data comprises no more than 3 transactional canonical data elements.

56. The method of claim 54, wherein said canonical data comprises relationship canonical data.

57. The method of claim 39, wherein said canonical data comprises relationship canonical data.

58. The method of claim 39, wherein said method is implemented in a computer system.

59. A method of alerting a user if a data structure is modified comprising the steps of:
(a) providing an inferential web comprising canonical data, said canonical data being organized into a plurality of nodes and at least one vertex connecting at least two connected nodes of said nodes, wherein said data structure comprises an inferential web that shows a user connections between at least two entities; and
(b) alerting the user if said inferential web is modified to form a modified inferential web.

60. The method of claim 59, wherein said inferential web is modified by a weight being assigned to said at least one vertex.

61. The method of claim 59, wherein said inferential web is modified by a weight of said at least one vertex being modified.

62. The method of claim 59, wherein said inferential web is modified by a direction being assigned to said at least one vertex.

63. The method of claim 59, wherein said inferential web is modified by a direction of said at least one vertex being modified.

64. The method of claim 59, wherein said inferential web is modified by collapsing at least a portion of said inferential web.

65. The method of claim 59, wherein said inferential web is modified by expanding at least a portion of said inferential web.

66. The method of claim 59, wherein said inferential web is modified by combining at least a portion of said inferential web with a second inferential web.

67. The method of claim 59, wherein said inferential web is modified by extracting at least a portion of said inferential web,

68. The method of claim 59, wherein at least some of said nodes are secure nodes.

69. The method of claim 59, wherein said at least two connected nodes comprises a plurality of connected nodes.

70. The method of claim 59, wherein said at least one vertex comprises a plurality of vertices.

71. The method of claim 59, wherein said inferential web is modified due to said inferential web being queried by said user.

72. The method of claim 59, wherein said user is alerted by a visible alert.

73. The method of claim 59, wherein said user is alerted by an audible alert.

74. The method of claim 59, wherein said canonical data comprises transactional canonical data.

75. The method of claim 74, wherein each of said transactional canonical data comprises no more than 3 transactional canonical data elements.

76. The method of claim 74, wherein said canonical data comprises relationship canonical data.

77. The method of claim 59, wherein said canonical data comprises relationship canonical data.

78. The method of claim 59, wherein said method is implemented in a computer system.

79. A computer system implementing a method for identifying data relationships, wherein said method comprises the steps of:
(a) providing source data; and
(b) reducing said data into canonical data, said canonical data being capable of being used in an inferential web that shows a user connections between at least two entities.

80. The computer system of claim 79, wherein said method further comprises the step of displaying said canonical data to a user on a visual display apparatus.

81. The computer system of claim 79, wherein said method further comprises the step of storing said canonical data on a data storage medium.

82. The computer system of claim 79, wherein said canonical data comprises transactional canonical data.

83. The computer system of claim 82, wherein each of said transactional canonical data comprises no more than 3 transactional canonical data elements.

84. The computer system of claim 82, wherein said canonical data comprises relationship canonical data.

85. The computer system of claim 79, wherein said canonical data comprises relationship canonical data.

86. The computer system of claim 79, wherein said method is implemented in a computer system.

87. A computer system implementing a method for structuring data, wherein said method comprises the steps of:
(a) providing a plurality of canonical data; and
(b) organizing said canonical data into an inferential web comprising a plurality of nodes and at least one vertex connecting at least two connected nodes of said plurality of nodes, wherein said inferential web shows a user connections between a plurality of entities.

88. The computer system of claim 87, wherein said method further comprises the step of displaying said inferential web to a user on a visual display apparatus.

89. The computer system of claim 87, wherein said method further comprises the step of storing said inferential web on a data storage medium.

90. The computer system of claim 87, wherein said canonical data is structured into said inferential web based on a plurality of connections present in said plurality of canonical data.

91. The computer system of claim 87, wherein said method further comprises the step of assigning weight to said at least one vertex.

92. The computer system of claim 87, wherein said method further comprises the step of assigning a direction to said at least one vertex.

93. The computer system of claim 87, wherein said canonical data comprises transactional canonical data.

94. The computer system of claim 93, wherein each of said transactional canonical data comprises no more than 3 transactional canonical data elements.

95. The computer system of claim 93, wherein said canonical data comprises relationship canonical data.

96. The computer system of claim 87, wherein said canonical data comprises relationship canonical data.

97. The computer system of claim 87, wherein said method is implemented in a computer system.

98. A computer system implementing a method of modifying a data structure, wherein said method comprises the steps of:
(a) providing an inferential web comprising canonical data, said canonical data being organized into a plurality of nodes and at least one vertex connecting at least two connected nodes of said nodes, wherein said data structure comprises an inferential web that shows a user connections between at least two entities; and
(b) modifying said inferential web to form a modified inferential web.

99. The computer system of claim 98, wherein said method further comprises the step of displaying said modified inferential web to a user on a visual display apparatus.

100. The computer system of claim 98, wherein said method further comprises the step of storing said modified inferential web on a data storage medium.

101. The computer system of claim 98, wherein step (b) comprises assigning a weight to said at least one vertex.

102. The computer system of claim 98, wherein step (b) comprises modifying a weight of said at least one vertex.

103. The computer system of claim 98, wherein step (b) comprises assigning a direction to said at least one vertex.

104. The computer system of claim 98, wherein step (b) comprises modifying a direction of said at least one vertex.

105. The computer system of claim 98, wherein step (b) comprises collapsing at least a portion of said inferential web.

106. The computer system of claim 98, wherein step (b) comprises expanding at least a portion of said inferential web.

107. The computer system of claim 98, wherein step (b) comprises combining at least a portion of said inferential web with a second inferential web.

108. The computer system of claim 98, wherein step (b) comprises extracting at least a portion of said inferential web,

109. The computer system of claim 98, wherein at least some of said nodes are secure nodes.

110. The computer system of claim 98, wherein said at least two connected nodes comprises a plurality of connected nodes.

111. The computer system of claim 98, wherein said at least one vertex comprises a plurality of vertices.

112. The computer system of claim 98, wherein said inferential web is modified due to said inferential web being queried by said user.

113. The computer system of claim 98, wherein said canonical data comprises transactional canonical data.

114. The computer system of claim 113, wherein each of said transactional canonical data comprises no more than 3 transactional canonical data elements.

115. The computer system of claim 113, wherein said canonical data comprises relationship canonical data.

116. The computer system of claim 98, wherein said canonical data comprises relationship canonical data.

117. The computer system of claim 98, wherein said method is implemented in a computer system.

118. A computer system implementing a method of alerting a user if a data structure is modified, wherein said method comprises the steps of:
(a) providing an inferential web comprising canonical data, said canonical data being organized into a plurality of nodes and at least one vertex connecting at least two connected nodes of said nodes, wherein said data structure comprises an inferential web that shows a user connections between at least two entities; and
(b) alerting the user if said inferential web is modified to form a modified inferential web.

119. The computer system of claim 118, wherein said inferential web is modified by a weight being assigned to said at least one vertex.

120. The computer system of claim 118, wherein said inferential web is modified by a weight of said at least one vertex being modified.

121. The computer system of claim 118, wherein said inferential web is modified by a direction being assigned to said at least one vertex.

122. The computer system of claim 118, wherein said inferential web is modified by a direction of said at least one vertex being modified.

123. The computer system of claim 118, wherein said inferential web is modified by collapsing at least a portion of said inferential web.

124. The computer system of claim 118, wherein said inferential web is modified by expanding at least a portion of said inferential web.

125. The computer system of claim 118, wherein said inferential web is modified by combining at least a portion of said inferential web with a second inferential web.

126. The computer system of claim 118, wherein said inferential web is modified by extracting at least a portion of said inferential web,

127. The computer system of claim 118, wherein at least some of said nodes are secure nodes.

128. The computer system of claim 118, wherein said at least two connected nodes comprises a plurality of connected nodes.

129. The computer system of claim 118, wherein said at least one vertex comprises a plurality of vertices.

130. The computer system of claim 118, wherein said inferential web is modified due to said inferential web being queried by said user.

131. The computer system of claim 118, wherein said user is alerted by a visible alert.

132. The computer system of claim 118, wherein said user is alerted by an audible alert.

133. The computer system of claim 118, wherein said canonical data comprises transactional canonical data.

134. The computer system of claim 133, wherein each of said transactional canonical data comprises no more than 3 transactional canonical data elements.

135. The computer system of claim 133, wherein said canonical data comprises relationship canonical data.

136. The computer system of claim 118, wherein said canonical data comprises relationship canonical data.

137. The computer system of claim 118, wherein said method is implemented in a computer system.

138. A machine-readable medium storing instructions that, if executed by a computer system, causes the computer system to perform method for identifying data relationships comprising the steps of:
(a) providing source data; and
(b) reducing said data into canonical data, said canonical data being capable of being used in an inferential web that shows a user connections between at least two entities.

139. The machine-readable medium of claim 138, wherein said method further comprises the step of displaying said canonical data to a user on a visual display apparatus.

140. The machine-readable medium of claim 138, wherein said method further comprises the step of storing said canonical data on a data storage medium.

141. The machine-readable medium of claim 138, wherein said canonical data comprises transactional canonical data.

142. The machine-readable medium of claim 141, wherein each of said transactional canonical data comprises no more than 3 transactional canonical data elements.

143. The machine-readable medium of claim 141, wherein said canonical data comprises relationship canonical data.

144. The machine-readable medium of claim 138, wherein said canonical data comprises relationship canonical data.

145. The machine-readable medium of claim 138, wherein said method is implemented in a computer system.

146. A machine-readable medium storing instructions that, if executed by a computer system, causes the computer system to perform a method for structuring data comprising the steps of:
(a) providing a plurality of canonical data; and
(b) organizing said canonical data into an inferential web comprising a plurality of nodes and at least one vertex connecting at least two connected nodes of said plurality of nodes, wherein said inferential web shows a user connections between a plurality of entities.

147. The machine-readable medium of claim 146, wherein said method further comprises the step of displaying said inferential web to a user on a visual display apparatus.

148. The machine-readable medium of claim 146, wherein said method further comprises the step of storing said inferential web on a data storage medium.

149. The machine-readable medium of claim 146, wherein said canonical data is structured into said inferential web based on a plurality of connections present in said plurality of canonical data.

150. The machine-readable medium of claim 146, wherein said method further comprises the step of assigning weight to said at least one vertex.

151. The machine-readable medium of claim 146, wherein said method further comprises the step of assigning a direction to said at least one vertex.

152. The machine-readable medium of claim 146, wherein said canonical data comprises transactional canonical data.

153. The machine-readable medium of claim 152, wherein each of said transactional canonical data comprises no more than 3 transactional canonical data elements.

154. The machine-readable medium of claim 152, wherein said canonical data comprises relationship canonical data.

155. The machine-readable medium of claim 146, wherein said canonical data comprises relationship canonical data.

156. The machine-readable medium of claim 146, wherein said method is implemented in a computer system.

157. A machine-readable medium storing instructions that, if executed by a computer system, causes the computer system to perform method of modifying a data structure comprising the steps of:
(a) providing an inferential web comprising canonical data, said canonical data being organized into a plurality of nodes and at least one vertex connecting at least two connected nodes of said nodes, wherein said data structure comprises an inferential web that shows a user connections between at least two entities; and
(b) modifying said inferential web to form a modified inferential web.

158. The machine-readable medium of claim 157, wherein said method further comprises the step of displaying said modified inferential web to a user on a visual display apparatus.

159. The machine-readable medium of claim 157, wherein said method further comprises the step of storing said modified inferential web on a data storage medium.

160. The machine-readable medium of claim 157, wherein step (b) comprises assigning a weight to said at least one vertex.

161. The machine-readable medium of claim 157, wherein step (b) comprises modifying a weight of said at least one vertex.

162. The machine-readable medium of claim 157, wherein step (b) comprises assigning a direction to said at least one vertex.

163. The machine-readable medium of claim 157, wherein step (b) comprises modifying a direction of said at least one vertex.

164. The machine-readable medium of claim 157, wherein step (b) comprises collapsing at least a portion of said inferential web.

165. The machine-readable medium of claim 157, wherein step (b) comprises expanding at least a portion of said inferential web.

166. The machine-readable medium of claim 157, wherein step (b) comprises combining at least a portion of said inferential web with a second inferential web.

167. The machine-readable medium of claim 157, wherein step (b) comprises extracting at least a portion of said inferential web,

168. The machine-readable medium of claim 157, wherein at least some of said nodes are secure nodes.

169. The machine-readable medium of claim 157, wherein said at least two connected nodes comprises a plurality of connected nodes.

170. The machine-readable medium of claim 157, wherein said at least one vertex comprises a plurality of vertices.

171. The machine-readable medium of claim 157, wherein said inferential web is modified due to said inferential web being queried by said user.

172. The machine-readable medium of claim 157, wherein said canonical data comprises transactional canonical data.

173. The machine-readable medium of claim 172, wherein each of said transactional canonical data comprises no more than 3 transactional canonical data elements.

174. The machine-readable medium of claim 172, wherein said canonical data comprises relationship canonical data.

175. The machine-readable medium of claim 157, wherein said canonical data comprises relationship canonical data.

176. The machine-readable medium of claim 157, wherein said method is implemented in a computer system.

177. A machine-readable medium storing instructions that, if executed by a computer system, causes the computer system to perform a method of alerting a user if a data structure is modified comprising the steps of:
(a) providing an inferential web comprising canonical data, said canonical data being organized into a plurality of nodes and at least one vertex connecting at least two connected nodes of said nodes, wherein said data structure comprises an inferential web that shows a user connections between at least two entities; and
(b) alerting the user if said inferential web is modified to form a modified inferential web.

178. The machine-readable medium of claim 177, wherein said inferential web is modified by a weight being assigned to said at least one vertex.

179. The machine-readable medium of claim 177, wherein said inferential web is modified by a weight of said at least one vertex being modified.

180. The machine-readable medium of claim 177, wherein said inferential web is modified by a direction being assigned to said at least one vertex.

181. The machine-readable medium of claim 177, wherein said inferential web is modified by a direction of said at least one vertex being modified.

182. The machine-readable medium of claim 177, wherein said inferential web is modified by collapsing at least a portion of said inferential web.

183. The machine-readable medium of claim 177, wherein said inferential web is modified by expanding at least a portion of said inferential web.

184. The machine-readable medium of claim 177, wherein said inferential web is modified by combining at least a portion of said inferential web with a second inferential web.

185. The machine-readable medium of claim 177, wherein said inferential web is modified by extracting at least a portion of said inferential web,

186. The machine-readable medium of claim 177, wherein at least some of said nodes are secure nodes.

187. The machine-readable medium of claim 177, wherein said at least two connected nodes comprises a plurality of connected nodes.

188. The machine-readable medium of claim 177, wherein said at least one vertex comprises a plurality of vertices.

189. The machine-readable medium of claim 177, wherein said inferential web is modified due to said inferential web being queried by said user.

190. The machine-readable medium of claim 177, wherein said user is alerted by a visible alert.

191. The machine-readable medium of claim 177, wherein said user is alerted by an audible alert.

192. The machine-readable medium of claim 177, wherein said canonical data comprises transactional canonical data.

193. The machine-readable medium of claim 133, wherein each of said transactional canonical data comprises no more than 3 transactional canonical data elements.

194. The machine-readable medium of claim 133, wherein said canonical data comprises relationship canonical data.

195. The machine-readable medium of claim 177, wherein said canonical data comprises relationship canonical data.

196. The machine-readable medium of claim 177, wherein said method is implemented in a computer system.
